(19) United States
(12) Patent Application Publication
(10) Pub. No.: US 2023/0090799 A1
(43) Pub. Date: Mar. 23, 2023

(54) DELETED OBJECT RETENTION IN A COMMUNICATION PLATFORM

(71) Applicant: Slack Technologies, LLC, San Francisco, CA (US)

(72) Inventors: Max Baez, Portola Valley, CA (US); Sarrangan Yoganathan, Bradford (CA); Luxuan Zhang, San Jose, CA (US); Eden Ghirmai, Oakland, CA (US)

(73) Assignee: Slack Technologies, LLC

(21) Appl. No.: 17/478,107

(22) Filed: Sep. 17, 2021

(51) Int. Cl. G06F 16/11; G06F 16/16

(52) U.S. Cl. CPC G06F 16/125; G06F 16/162

(57) ABSTRACT

Techniques for specifying a deleted data retention rule for deleted objects in a communication platform are described herein. Deleted objects include objects (e.g., files, reaction emojis, etc.), that are transmitted and/or accessible via the communication platform and subsequently deleted. An administrative user of an organization can establish one or more deleted data retention rules (e.g., policies) for the organization. A deleted data retention rule can include a policy for continued storage of a deleted object after receiving a request to delete the object from the communication platform. In response to receiving the request to delete the object, and based on a deleted data retention rule, the communication platform can remove the object from view by the end user (e.g., remove from an interface), but can continue to store the object in a database for a period of time specified in the deleted data retention rule.

### TECHNICAL FIELD

Many organizations and users thereof utilize group-based communication platforms to communicate with other members within an organization and/or with members of other organizations. The data transmitted via the group-based communication platform, such as in the form of messages, attachments thereto, or the like, may be stored in a database corresponding to an associated organization (e.g., organization associated with the sender or one or more recipients of the message). In some examples, an organization may establish a data retention policy, indicating a particular time period (e.g., six months, one year, etc.) for retaining stored messages, files, and the like in the database. In some examples, the organization can establish a data retention policy with regard to a portion of users of the organization, such as for discovery of information during a legal process (e.g., merger, acquisition, lawsuit, etc.). However, if a user of the portion of users of the organization deletes a file or other object from the communication platform, that file may not be stored in accordance with the data retention policy. Enabling file deletion with respect to a user account could potentially lead to complications during legal processes. To limit complications and potential liability, organizations can block users from deleting the files and other objects. However, blocking the function to delete files and other objects can result in a cluttered interface and a negative user experience.

### BRIEF DESCRIPTION OF THE DRAWINGS

The detailed description is described with reference to the accompanying figures. In the figures, the left-most digit of a reference number identifies the figure in which the reference number first appears. The use of the same reference numbers in different figures indicates similar or identical components or features. The figures are not drawn to scale.

FIG. 1 is an example system for performing techniques described herein.

FIGS. 2A and 2B illustrate example user interfaces for specifying a deleted data retention rule associated with a deleted object, as described herein.

FIG. 3 illustrates an example user interface for viewing objects subject to a deleted data retention rule, as described herein.

FIG. 4 illustrates an example process for storing objects based on a deleted data retention rule, as described herein.

FIG. 5 illustrates an example process for rendering data subject to a deleted data retention rule, as described herein.

FIG. 6 illustrates an example process for removing a previously deleted object from a database after a time period associated with a deleted data retention rule, as described herein.

FIG. 7 illustrates an example process for enabling an end user access to a deleted object for a period of time after deletion, as described herein.

### DETAILED DESCRIPTION

Techniques for specifying a deleted data retention rule for objects that are transmitted and/or accessible via a communication platform, and subsequently deleted (e.g., deleted objects), are described herein. The communication platform can be a group-based communication platform, a channel-based messaging platform, and/or any other platform for facilitating communication between and among users. In an example, a user of an organization can establish one or more deleted data retention rules (e.g., policies) for an organization. A deleted data retention rule can include a policy for continued storage of an object after receiving a request to delete the object, such as from another user of the organization. That is, after receiving an indication of deletion of an object, the communication platform can remove the object from view by the end user (e.g., remove from an interface of the communication platform), but can continue to store the object in a datastore.

As discussed above, the communication platform previously enabled organization owners or administrative accounts to establish a data retention policy with regard to messages transmitted via the communication platform. Such a policy could be applied to all or a portion of the users of an organization and could include the continued storage of edited and deleted messages, such as for discovery of information during a legal process. However, if a user of the organization that is subject to the data retention policy deleted a file or other object from a virtual space (e.g., workspace, communication platform, direct message instance, board, audio or video clip or conversation, transcript of an audio or video clip or conversation, etc.) of the communication platform, that file or other object would not be stored in accordance with the data retention policy. As such, enabling object deletion in an organization could potentially lead to organizational liability and complications during legal processes. To limit liability and complications, organizations can block users from deleting files and other objects. However, blocking deletion can result in cluttered user interfaces and can potentially result in confusion, such as to what version of a document is a current or most recent version. As such, blocking deletion can limit the overall effectiveness of organization within the communication platform and can lead to a negative user experience.

Techniques described herein enable a user (e.g., administrative user) to establish a deleted data retention policy with respect to an organization. The deleted data retention policy can enable a continued storage of objects (e.g., files (e.g., documents, video files, audio files, etc.), transcripts (e.g., textual representation of audio conversations or clips, video conversations or clips, etc.), reaction emojis, etc.) after a deletion thereof from a virtual space of the communication platform. The objects can include objects that are transmitted via the virtual space, such as in association with a message, and/or objects that are uploaded directly to the virtual space. That is, the objects can include objects that are available for viewing and/or accessing via the virtual space. For example, the object can include a document that is transmitted via a virtual space in association with a message. For another example, the object can include a document that is uploaded directly to or otherwise associated (e.g., link to third-party document presented in association) with the virtual space.

In various examples, the user can specify a deleted data retention rule (e.g., store in perpetuity, store for a period of time after deletion, store until a particular date, etc.) associated with objects of a particular type (e.g., document, audio file, video file, transcript, reaction emoji, etc.) or types, such that different types of objects can be stored for different periods of time. For example, the user can specify that documents associated with one or more virtual spaces of the communication platform can be stored by the communication platform for a first period of time (e.g., in perpetuity, 90 days, 2 years, etc.) after an associated deletion request is received and that reactions (e.g., reaction emojis) associated with messages transmitted via a virtual space can be stored by the communication platform for a second period of time (e.g., 180 days, 1 year, etc.) after an associated deletion request is received, the second time being substantially the same as, or different from, the first period of time. Additionally or in the alternative, the user can specify a deleted data retention rule associated with a particular virtual space and/or a type of virtual space. That is, the user can cause objects associated with the particular virtual space and/or a particular type of virtual space for which a deletion request has been received to be stored for the period of time associated with the deleted data retention rule. For example, the user can establish a first deleted data retention rule associated with direct messaging instances and a second deleted data retention rule associated with communication channels.

In various examples, the communication platform can receive a request, from a client associated with a user of the organization, to delete an object associated with a virtual space. The object can include an object that is or has been transmitted via the virtual space, such as in association with a message and/or is uploaded directly to the virtual space, such as for view and/or access by members (e.g., users) of the virtual space. In some examples, the communication platform can identify an object type of the object and/or a virtual space associated with the request. Based on the object type and/or the virtual space, the communication platform can determine whether a deleted data retention rule is associated with the object. Based on a determination that no deleted data retention rule is associated with the object, the communication platform can cause the object to be deleted (e.g., hard delete) from a database of the communication platform. As such, the communication platform can remove the object from the database such that the object is no longer accessible via the communication platform.

Based on a determination that a deleted data retention rule is associated with the object, the communication platform can remove an identifier associated with the object from an interface associated with the virtual space. That is, the deleted object can be rendered inaccessible to members of the virtual space (e.g., end users). Additionally, the communication platform can cause an indicator to be associated with the object in the datastore. The indicator can include a flag or other type of indicator to signal that the object is subject to a deleted data retention rule. The communication platform can store the object with the indicator in the database based on the deleted data retention rule associated with the object. For example, a user can upload a file to a communication channel. The communication platform can store the file in association with the communication channel based on the upload. At a later time, the user can subsequently request to delete the file from the communication channel. Based on a determination that the file is associated with a deleted data retention rule, the communication platform can associate an indicator with the file stored in the database and can remove an identifier associated with the file from an interface of the communication channel. As such, the file can continue to be stored in the database according to the deleted data retention rule, but may be inaccessible via the communication channel.

In various examples, the communication platform can manage the database associated with the organization. In some examples, the communication platform can determine dates/times associated with objects requested to be deleted (e.g., date and/or time that the object was deleted from a virtual space) stored in the database. In some examples, such as when the deleted data retention rule includes a finite period of time (e.g., time that is less than storage in perpetuity) for continued storage of deleted objects, the communication platform can identify one or more deleted objects that exceed the finite period of time associated with the deleted data retention rule. In at least one example, the communication platform can cause the deleted object(s) to be removed from the database, based on the expiration of the finite period of time.

In some examples, the communication platform can receive, from a computing device associated with an administrative user of the organization, a request to export all or a portion of the data stored in the database associated with the organization. In some examples, the request can include a request to export deleted objects stored in the database. In such examples, the communication platform can identify one or more objects including an indicator associated with a deleted data retention rule and can cause data associated with the one or more object(s) to be rendered on a display of the computing device associated with the administrative user. The data associated with the object(s) can include respective links (e.g., URLs) indicating a location of the respective object(s), can include names of the object(s), metadata associated with the object (e.g., date/time associated with transmission and/or upload to a virtual space, date/time associated with deletion from the virtual space, an identifier associated with the virtual space, etc.) and/or other data associated with the object(s).

Additionally or in the alternative, the communication platform can receive, from a third-party computing device associated with a third-party service provider, a request to access all or a portion of the data stored in the database associated with the organization. For example, the third-party service provider can include an electronic discovery service provider configured to identify, collect, and provide electronic data in response to a request for production, such as in association with a legal proceeding. In some examples, the communication platform can verify an authenticity of the request from the third-party computing device based on a token or other verifier associated with the request. In such examples, an administrative user of the organization and/or the communication platform can provide the token or other verifier to the third-party computing device for use when submitting requests for data. Based on a verification of the request, the communication platform can identify the requested data and provide the data to the third-party computing device. In at least one example, the communication platform can identify the data based on the indicators associated therewith. In such an example, the communication platform can be configured to send requested data, including previously deleted objects, to the third-party service provider. Though described herein primarily as providing deleted data in response to requests form an administrator and/or a third-party service provider, this is not intended to be so limiting, and additional or alternative data may be provided in response to requests. That is, the communication platform can be configured to additionally or alternatively provide non-deleted data that is stored in association with an organization, such as by utilizing techniques described in U.S. patent application Ser. No. 16/948,299, filed Sep. 11, 2020, and entitled “Data Retention in Group-Based Communication Platform,” the entire contents of which are incorporated herein by reference.

Techniques described herein decrease a total amount of data stored in a database associated with an organization, thereby improving the functioning of a server computing device associated with a group-based communication platform. As discussed above, existing technologies may require that organizations that are or may be subject to legal proceedings store all data transmitted via the communication platform. Due to the legal proceedings, the organizations can be required to block users from deleting any objects, such as files uploaded or transmitted via a virtual space. This can require a significant amount of storage space and processing power to manage the data stored in the database.

Unlike the existing technologies, the techniques described herein enable an organization to designate a deleted data retention rule, such as to retain particular types of objects of interest in a database, while enabling other types of objects to be deleted. By enabling the deletion of particular types of objects, the deleted data retention rule can reduce a total amount of stored data associated therewith. Because the techniques described herein enable any organization, even those that are subject or that may be subject to legal proceedings, to designate a deleted data retention rule, the techniques described herein reduce a total amount of data stored in association with an organization, while also enabling the organization to remain in compliance with one or more data retention policies associated with litigation or another storage request. As such, the techniques described herein may improve the functioning of a server computing device by reducing an amount of memory and processing power required to manage the data stored in the memory.

Additionally, blocking users from deleting objects in order to comply with a mandated data retention policy can lead to disorganized and unwieldy user interfaces that include a plurality of old and outdated documents. As such, blocking users from deleting objects can render the communication platform inefficient and ineffective as a means for sharing up-to-date data with other users. Unlike the existing technologies, the techniques described herein improve the functioning of a user computing device by enabling users to remove objects from a user interface, while still retaining the objects (or select objects) in a database, such as for electronic discovery, statistical analysis (e.g., user and/or organization integration analysis), and/or the like. Utilizing the techniques described herein, a user can quickly and efficiently identify most recent and/or up-to-date objects transmitted and/or uploaded to virtual spaces of the organization. At least because the user is not required to sift through the plurality of old and outdated documents to identify the most recent and relevant documents, the techniques described herein can reduce an amount of processing power and memory required to identify relevant documents.

Additionally, the techniques described herein can improve an electronic discovery of information associated with a communication platform, such as a group-based communication platform. As described above, conventional systems enabled the storage of messages for electronic discovery and other purposes. In some examples, the message storage included the storage of both deleted and non-deleted messages transmitted via the communication platform. However, a user of the conventional systems can delete an object independent of a message (e.g., deleted from a message without message deletion, deleted from a virtual space, etc.), and render the object undiscoverable. Unlike these conventional systems, the techniques described herein provide a means by which all data, both deleted and non-deleted, can be discoverable. Because the techniques described herein provide a means by which previously undiscoverable data can be accessible, the techniques described herein improve the electronic discovery of information associated with an organization and/or a user.

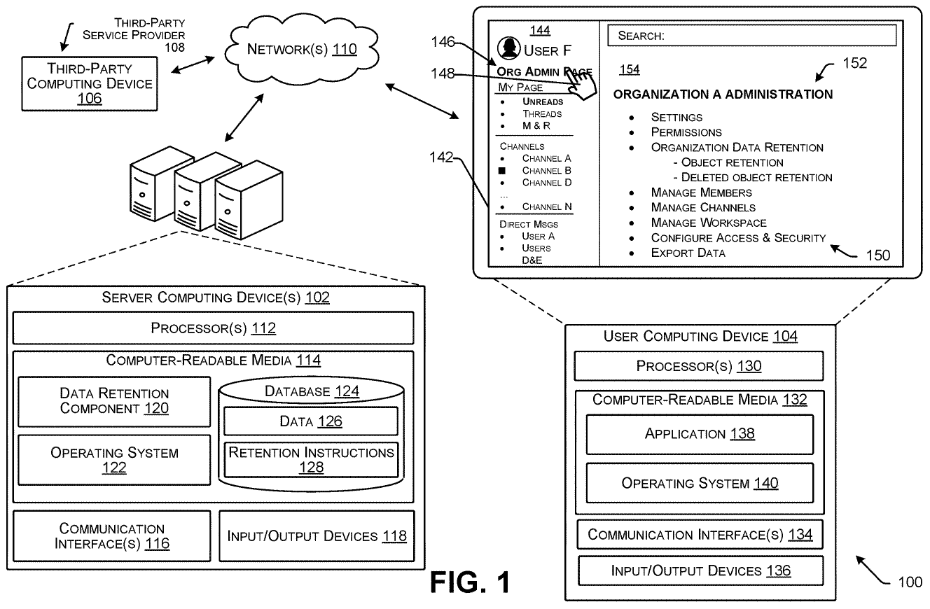

While the description above describes retaining, in a database, particular types of objects uploaded or transmitted via a virtual space of a communication platform after a deletion thereof, techniques described herein can similarly be applicable to other methods of communication, such as electronic mail (email), short message service (text) messaging, and the like. For example, a text message service provider can establish a deleted data retention rule to store deleted texts for 5 years. The text message service provider can additionally include a specified deleted data retention rule associated with a particular organization account, to store deleted texts transmitted to or from a user account associated with the organization account. The text message service provider can thus retain the deleted texts sent in association with the organization account for a period of time designated by the specified deleted data retention rule. As such, techniques described herein are not limited to group-based communication platforms. Additional details and examples are described below with reference to FIGS. 1-7.

FIG. 1 illustrates a block diagram illustrating an example system 100 of computing devices usable to implement example techniques described herein. In at least one example, the example system 100 can be associated with a communication platform that can leverage a network-based computing system to enable users of the communication platform to exchange data. In at least one example, the communication platform can be “group-based” such that the platform, and associated systems, communication channels, messages, and/or virtual spaces, have security (that can be defined by permissions) to limit access to a defined group of users. In some examples, such groups of users can be defined by group identifies, as described above, which can be associated with common access credentials, domains, or the like. In some examples, the communication platform can be a hub, offering a secure and private virtual space to enable users to chat, meet, call, collaborate, or otherwise communicate between or among each other. As described above, each group can be associated with a workspace, enabling users associated with the group to chat, meet, call, collaborate, or otherwise communicate between or among each other in a secure and private virtual space. In some examples, the communication platform is a channel-based messaging platform—in other words, channels of the communication platform can be a central component of the manner of communicating and providing content via the communication platform. In some examples, members of a group, and thus workspace, can be associated with a same organization. In some examples, members of a group, and thus workspace, can be associated with different organizations (e.g., entities with different organization identifiers).

FIG. 1 illustrates example system 100 as comprising example computing devices including communication platform server(s) 102 and one or more computing devices 104 (e.g., user computing device(s)) associated with a first user, that interact over a network 110. By way of example and not limitation, the communication platform server(s) 102 can be representative of servers used to implement a communication platform system, the first computing device(s) 104 can be representative of user device(s) associated with a first user. The user computing device(s) 104 may be any suitable type of computing device, e.g., portable, semi-portable, semi-stationary, or stationary. Some examples of the user computing device(s) 104 can include a tablet computing device, a smart phone, a mobile communication device, a laptop, a netbook, a desktop computing device, a terminal computing device, a wearable computing device, an augmented reality device, an Internet of Things (IOT) device, or any other computing device capable of sending communications and performing the functions according to the techniques described herein.

In at least one example, the example system 100 can be associated with a communication platform that can leverage a network-based computing system to enable users of the communication platform to exchange data. In at least one example, the communication platform can be “group-based” such that the platform, and associated systems, communication channels, messages, and/or virtual spaces, have security (that can be defined by permissions) to limit access to a defined group of users. In some examples, such groups of users can be defined by group identifies, as described above, which can be associated with common access credentials, domains, or the like. In some examples, the communication platform can be a hub, offering a secure and private virtual space to enable users to chat, meet, call, collaborate, or otherwise communicate between or among each other. As described above, each group can be associated with a workspace, enabling users associated with the group to chat, meet, call, collaborate, or otherwise communicate between or among each other in a secure and private virtual space. In some examples, members of a group, and thus workspace, can be associated with a same organization. In some examples, members of a group, and thus workspace, can be associated with different organizations (e.g., entities with different organization identifiers).

In at least one example, the example system 100 can include one or more server computing devices (or server(s)) 102. In at least one example, the server(s) 102 can include one or more servers or other types of computing devices that can be embodied in any number of ways. For example, in the example of a server, the functional components and data can be implemented on a single server, a cluster of servers, a server farm or data center, a cloud-hosted computing service, a cloud-hosted storage service, and so forth, although other computer architectures can additionally or alternatively be used.

In at least one example, the server(s) 102 can communicate with a user computing device 104 and/or one or more third-party computing devices 106 associated with a third-party service provider 108 (e.g., third-party resource) via one or more network(s) 110. That is, the server(s) 102, the user computing device 104, and the third-party computing device(s) 106 can transmit, receive, and/or store data (e.g., content, information, or the like) using the network(s) 110, as described herein. The user computing device 104 and the third-party computing device(s) 106 can be any suitable type of computing device, e.g., portable, semi-portable, semi-stationary, or stationary. Some examples of the third-party computing device(s) 106 can include a server computing device, such as that described above with regard to the server(s) 102, a desktop computing device, a terminal computing device, or the like.

Some examples of the user computing device 104 can include a tablet computing device, a smart phone, a mobile communication device, a laptop, a netbook, a desktop computing device, a terminal computing device, a wearable computing device, an augmented reality device, an Internet of Things (IOT) device, or any other computing device capable of sending communications and performing the functions according to the techniques described herein. While a single user computing device 104 is shown, in practice, the example system 100 can include multiple (e.g., tens of, hundreds of, thousands of, millions of) user computing devices. In at least one example, user computing devices, such as the user computing device 104, can be operable by users to, among other things, access communication services via the communication platform. A user can be an individual, a group of individuals, an employer, an enterprise, an organization, or the like.

The network(s) 110 can include, but are not limited to, any type of network known in the art, such as a local area network or a wide area network, the Internet, a wireless network, a cellular network, a local wireless network, Wi-Fi and/or close-range wireless communications, Bluetooth®, Bluetooth Low Energy (BLE), Near Field Communication (NFC), a wired network, or any other such network, or any combination thereof. Components used for such communications can depend at least in part upon the type of network, the environment selected, or both. Protocols for communicating over such network(s) 110 are well known and are not discussed herein in detail.

In at least one example, the server(s) 102 can include one or more processors 112, computer-readable media 114, one or more communication interfaces 116, and input/output devices 118. Though not illustrated in FIG. 1, the third-party computing device(s) 106 can additionally include one or more processors, such as processor(s) 112, computer-readable media, such as computer-readable media 114, communication interface(s), such as communication interface(s) 116, and/or input/output devices, such as input/output devices 118.

In at least one example, each processor of the processor(s) 112 can be a single processing unit or multiple processing units and can include single or multiple computing units or multiple processing cores. The processor(s) 112 can be implemented as one or more microprocessors, microcomputers, microcontrollers, digital signal processors, central processing units (CPUs), graphics processing units (GPUs), state machines, logic circuitries, and/or any devices that manipulate signals based on operational instructions. For example, the processor(s) 112 can be one or more hardware processors and/or logic circuits of any suitable type specifically programmed or configured to execute the algorithms and processes described herein. The processor(s) 112 can be configured to fetch and execute computer-readable instructions stored in the computer-readable media, which can program the processor(s) to perform the functions described herein.

The computer-readable media 114 can include volatile and nonvolatile memory and/or removable and non-removable media implemented in any type of technology for storage of data, such as computer-readable instructions, data structures, program modules, or other data. Such computer-readable media 114 can include, but is not limited to, RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired data and that can be accessed by a computing device. Depending on the configuration of the server(s) 102, the computer-readable media 114 can be a type of computer-readable storage media and/or can be a tangible non-transitory media to the extent that when mentioned, non-transitory computer-readable media exclude media such as energy, carrier signals, electromagnetic waves, and signals per se.

The computer-readable media 114 can be used to store any number of functional components that are executable by the processor(s) 112. In many implementations, these functional components comprise instructions or programs that are executable by the processor(s) 112 and that, when executed, specifically configure the processor(s) 112 to perform the actions attributed above to the server(s) 102. Functional components stored in the computer-readable media can optionally include a data retention component 120, an operating system 122, and a database 124.

In various examples, the data retention component 120 can be configured to receive a first request from a user computing device 104 to establish one or more deleted data retention rules with regard to an organization associated with the user computing device 104. In some examples, the user computing device 104 can include a computing device associated with an administrative account of the organization. In such examples, the administrative account can be associated with an administrator responsible for managing user accounts, communication channels, workspaces, or the like. In some examples, the administrator can manage settings, permissions, workspace design, access, security, data storage, data access, and other functions associated with communications via the communication platform. In various examples, the administrator can be a user having a particular role within an organization (e.g., owner, administrator, etc.)

In various examples, the deleted data retention rule(s) can include one or more retention periods for storing objects associated with an organization that are requested to be deleted (e.g., deleted objects). The deleted objects can include objects that are transmitted or otherwise available via a virtual space (e.g., workspace, communication channel, direct message instance, board, audio or video conversation, audio or video clip, etc.) such as in association with a message, and/or objects that are uploaded directly to the virtual space. That is, the deleted objects can include objects that were previously available for viewing and/or accessing via the virtual space. For example, the object can include a document that is transmitted via a virtual space in association with a message, and is subsequently deleted. In various examples, the data retention component 120 can be configured to establish one or more data retention policies for non-deleted messages and/or store deleted messages in the database 124, such as utilizing the techniques described in U.S. patent application Ser. No. 16/948,299, incorporated herein by reference above.

In at least one example, an object transmitted in association with a message can be presented via an interface of the communication platform in association with the message. However, the object and the message can be subject to two different data retention policies (e.g., amount of time data is retained and/or available for viewing via the interface) and/or two different deleted data retention policies. Accordingly, in at least one example, the data retention component 120 can store objects separately from messages associated therewith. In such examples, the data retention component 120 can be configured to associate indicators with objects transmitted in association with a message and continue to store the object after deletion, regardless of the status of the message (e.g., permanently deleted, stored but not available, not deleted, etc.).

In various examples, the data retention component 120 can identify one or more data retention rules associated with the messages and/or the objects available via an interface. In at least one example, a data retention rule can include a policy associated with rendering the messages and/or the objects via the interface. That is, the data retention rule can include an amount of time that a message and/or an object is available for accessing by a member of a virtual space. In some examples, messages transmitted via the virtual space can be subject to a first data retention rule with a first period of time and objects available via the virtual space can be subject to a second data retention rule, which can be substantially the same (e.g., within 5 minutes, 5 hours, etc.) or different from the first data retention rule. In some examples, the data retention component 120 can be configured to update the interface based on the first data retention rule and/or the second data retention rule. As an illustrative, non-limiting example, messages can be available for viewing in communication channel for a first period of time (e.g., first data retention period with a first period of time of 90 days, 180 days, 1 year, etc.) and files (e.g., documents, audio files, video files, etc.) can be available for a second period of time (e.g., second data retention period with a second period of time of 180 days, 1 year, 2 years, etc.) that is longer than the first period of time. The data retention component 120 can determine that a current time is after an end of the first period of time (and before the second period of time) associated with a message transmitted via the communication channel with a file associated therewith. The data retention component 120 can modify the interface to remove the message from the interface and cause a presentation of the file in another location of the interface (e.g., available in an “all files” menu, etc.). The data retention component 120 can cause the file that was transmitted in association with the message to be available via the virtual space until a current time is after an end of the second period of time. Based on a determination that the second period of time has elapsed, the data retention component 120 can delete the file from the virtual space.

In various examples, the data retention component 120 can determine, after a deletion of a message and/or an object previously available via a virtual space, whether one or more deleted data retention rules are associated therewith. For example, the data retention component 120 can determine whether the deleted data retention rule(s) are associated therewith based on the message, an object type of the object, a virtual space, and/or a type of virtual space associated with the object and/or the message. In at least one example, the message can be associated with a first deleted data retention rule with a first period of time and an object can be associated with a second deleted data retention rule with a second period of time, which can be substantially the same (e.g., within 1 minute, 1 day, etc.) or different from the first period of time. As such, an object provided in association with a message transmitted via a virtual space, and subsequently deleted, together with the message or independently from the message, can be retained for a retention period associated with a deleted data retention rule separate and apart from the associated message.

A retention period can include an indefinite period (e.g., store deleted data in perpetuity), a determined time period (e.g., five months, 10 months, 1 year, 2 years, etc.), a designated date (e.g., store data associated with the organization until a future date), a specified event (e.g., an action that takes place with regard to the communication platform, organization, etc.), or the like. In at least one example, the retention period(s) can each include a time period designating an amount of time that a deleted object associated with an organization will be stored in the database 124, such as in data 126 associated with the organization.

In some examples, the data retention component 120 can be configured to store all objects that are transmitted or uploaded to virtual spaces of an organization and subsequently deleted. In various examples, the data retention component 120 can identify a retention period (e.g., in perpetuity, for one year, 2 years, etc.) associated with the organization, such as based on the first request, and can continue to store the objects in the database 124 after a deletion thereof. In some examples, the continued storage of deleted objects for the retention period can include a default setting associated with an organization. In such examples, the data retention component 120 can be configured to store the deleted objects for the retention period without receiving the first request from the administrative user. For example, the data retention component 120 can include a default setting for deleted objects that causes objects to continue to be stored, after deletion thereof, for a period of time (e.g., 1 week, 1 month, 6 months, etc.).

In various examples, the data retention component 120 can be configured to store deleted objects based on a type of object (e.g., object type) associated therewith. That is, the user can specify, in the first request, a particular retention period for a particular type of object. Non-limiting examples of object types of objects that can be available via the communication platform and subsequently deleted are files (e.g., documents, audio files, video files, etc.), transcripts, reaction emojis, calendar events, workflows, and the like. For example, the first request can include a request to store deleted files for a first period of time and deleted reaction emojis for a second period of time. In various examples, the data retention component 120 can be configured to identify an object type that is associated with a deleted object, such as responsive to receiving a second request to delete the object, and can store the deleted object based on the object type.

In some examples, the data retention component 120 can be configured to store deleted objects based on a virtual space associated therewith. That is, the user can specify, in the first request, a particular retention period for deleted objects that are transmitted or otherwise available via a particular virtual space. In such an example, the first request can include a virtual space identifier associated with the particular virtual space. For example, the first request can include a request to store deleted objects previously available (e.g., prior to a deletion thereof) via a first virtual space for a first period of time and deleted objects available via a second virtual space for a second period of time. In some examples, the data retention component 120 can be configured to store deleted objects based on a type of virtual space associated therewith. That is, the user can specify, in the first request, a particular retention period for a particular type of virtual space. For example, the first request can include a request to store deleted objects previously available via a first type of virtual space (e.g., communication channels, etc.) for a first retention period and deleted objects previously available via a second type of virtual space (e.g., direct messaging instance, etc.) for a second retention period.

In various examples, the data retention component 120 can receive the first request, from the user computing device 104, and can store the data retention rule(s) in the database 124, such as in retention instructions 128. In various examples, the data retention component 120 can be configured to receive a second request, from another user computing device 104, including a request to delete an object that is available via a virtual space. The object can include an object that was previously transmitted and/or uploaded directly to the virtual space, and thus made available to one or more members of the virtual space for accessing and/or viewing. Though primarily described herein as being available via a single virtual space, this is not intended to be so limiting, and a particular object can be available via one or more virtual spaces. For example, a user can upload a document to two or more virtual spaces. In some examples, the communication platform can enable the other user to delete the object from the two or more virtual spaces concurrently, such as with a “delete from all channels” selectable option. In such examples, the data retention component 120 can be configured to identify each instance of the object that is available via the communication platform in association with the organization, and can cause the object to be removed from interfaces associated with the two or more virtual spaces such that the object is no longer available therethrough.

In at least one example, in response to receiving the second request to delete the object, the data retention component 120 can cause the object (instance of the object) to be removed from presentation via an interface of the communication platform. The interface can include an interface of an associated virtual space through which the object was previously made available to members of the virtual space. In various examples, the data retention component 120 can identify a grace period associated with the second request. In such examples, the grace period can include a time period (e.g., 5 seconds, 10 seconds, 1 minute, 5 minutes, etc.) in which the other user can reverse the deletion of the object identified in the second request. That is, the data retention component 120 can enable the other user to retract and cancel the request to delete the object during the grace period, causing the object to again be available for access and/or viewing via the associated virtual space(s). In various examples, in response to receiving a third request to retract the object deletion request (e.g., cancel the second request and not delete the selected object), the data retention component 120 can determine whether a current time is within the grace period from deletion. Based on a determination that the current time is within the grace period, the data retention component 120 can cause a presentation of the selected object via the virtual space associated therewith. Based on a determination that the current time is after an end of the grace period, the data retention component 120 can identify whether a deleted data retention rule is associated with the selected object. In various examples, the data retention component 120 can determine whether the deleted data retention rule is associated with the selected object based on an object type, virtual space, and/or type of virtual space associated therewith.

Based on a determination that the deleted data retention rule is not associated with the object, the data retention component 120 can cause the object to be deleted or otherwise removed from the database 124. Based on a determination that the deleted data retention rule is associated with the object, the data retention component 120 can cause an indicator to be associated with the message. The indicator can include a flag or other type of indicator to signal that the object is subject to a deleted data retention rule. That is, the indicator can provide an indication to not delete the object based on the deleted data retention rule. In various examples, the indicator can include an indication of the retention period for the deleted data retention rule associated with the object.

In various examples, the data retention component 120 can be configured to identify the retention period based in part on the object type, the virtual space, and/or the type of virtual space associated with the object. In at least one example, the data retention component 120 can be configured to store the object with the indicator in the database 124 for the retention period. For example, the object can include a document that was previously available via a particular virtual space. The data retention component 120 can determine, based on the object type and/or the particular virtual space, that the retention period is six months. The data retention component can thus associate the indicator with the object in the database 124, and continue to store the object for six months after a deletion thereof.

In some examples, the data retention component 120 can be configured to identify a discrepancy between two different retention periods associated with an object. In such examples, the data retention component 120 can select the longer of the two retention periods for continued storage of the deleted object. For example, an object of a particular type can have associated therewith a first retention period and a virtual space via which the object was accessible can have associated therewith a second retention period that is shorter than the first retention period. Based on a determination that the first retention period is longer than the second retention period, the data retention component 120 can store the deleted object in the database 124 for the first retention period.

In various examples, the data retention component 120 can be configured to remove the indicator associated with a deleted object after an end of the retention period associated therewith. In such examples, the data retention component 120 can determine when a current time is after the retention period, and can remove the indicator. In some examples, in response to removing the indicator associated with the deleted object, the data retention component 120 can additionally delete or otherwise purge the deleted object from the database 124. In various examples, the data retention component 120 can delete or otherwise purge data 126 periodically (e.g., once per day, twice per day, once per week, etc.). In some examples, the data retention component can delete or otherwise purge the data 126 intermittently and/or when instructed by an administrator of the organization.

In various examples, the data retention component 120 can receive a request to export data 126 from the database 124. In some examples, the request to export data can include a request to export all or a portion of the data stored in association with the organization. In some examples, the request to export data can include a request to export deleted objects stored in association with the organization. In various examples, the request to export data 126 can be received from a user computing device 104 associated with the administrator and/or owner of the organization. In some examples, responsive to receiving the request to export data 126, the data retention component 120 can identify one or more deleted objects including an indicator associated with a deleted data retention rule. The data retention component 120 can cause the one or more deleted objects to be rendered on a display of the user computing device 104 associated with the administrator and/or owner of the organization. For example, an administrator can request, at a first time, that files available via virtual spaces associated with the organization be stored according to a deleted data retention rule. Based on the request, the data retention component 120 can store objects that are transmitted and/or uploaded via virtual spaces of the organization and subsequently deleted in the database 124 according to the deleted data retention rule. At a second time after the first time, the administrator can request to export or otherwise view the data 126 (e.g., deleted object) associated with the organization (e.g., the deleted data retention rule). Based on the request to export or otherwise view the data, the data retention component 120 can cause the data 126 stored in association with the deleted objects to be presented on the user computing device 104 associated with the administrator.

Additionally or in the alternative, the data retention component 120 can receive a request, from an administrative user, to grant access permissions to the data 126 to a third-party service provider 108, such as for an export of the data 126 in association with an electronic discovery. In at least one example, the third-party service provider can include a third-party or resource separate from the organization that is associated with managing a legal proceeding on behalf of the organization. In various examples, in response to the request to grant access permissions to the third-party service provider 108, the data retention component 120 can generate and transmit a token or access code to the third-party computing device 106 associated with the third-party service provider 108. In various examples, the token or access code can provide a means by which the data retention component 120 can authenticate a subsequent request for data 126.

In various examples, the data retention component 120 can, at a later time, receive, from the third-party computing device 106, a request to export data 126 associated with the organization from the database 124. In various examples, the request can include the token or access code previously provided to the third-party service provider 108. In such examples, the data retention component 120 can verify authenticity of the request to export data 126 received from the third-party computing device 106, and can send the requested data thereto. In various examples, the request to export data can be received via an application programming interface (API). In such examples, the API can be configured to facilitate communication between the third-party computing device 106 and the server 102 (e.g., a data retention component 120 thereof).

In some examples, the administrator can be an administrator of a first organization that is associated with a shared channel between the first organization and a second organization (or one or more other organizations). In some examples, the first organization can include a same deleted data retention rule as the second (or other) organization. In some examples, the first organization can include a different deleted data retention rule from the second (or other) organization. In such examples, the data retention component 120 can store deleted objects (e.g., data 126) associated with the first organization for a first period of time associated with the first deleted data retention rule and data associated with the second organization for a second (different) period of time associated with a second deleted data retention rule.

In some examples, the database 124 can be partitioned into discrete items of data that can be accessed and managed individually (e.g., data shards). Data shards can simplify many technical tasks, such as data retention, unfurling (e.g., detecting that message contents include a link, crawling the link's metadata, and determining a uniform summary of the metadata), and integration settings. In some examples, data shards can be associated with organizations, groups (e.g., workspaces), communication channels, users, or the like.

In some examples, the data 126 and/or retention instructions 128 can include discrete shards for each individual organization, including data related to a particular organization identification. For example, a database shard can store electronic communication data associated with members of a particular organization, which enables members of that particular organization to communicate and exchange data with other members of the same organization in real time or near-real time. In this example, the organization itself can be the owner of the database shard and has control over where and how the related data is stored. In some examples, a database shard can store data related to two or more organizations (e.g., as in a shared channel).

In at least one example, the operating system 122 can manage the processor(s) 112, computer-readable media 114, hardware, software, etc. of the server(s) 102.

The communication interface(s) 116 can include one or more interfaces and hardware components for enabling communication with various other devices (e.g., the user computing device 104), such as over the network(s) 110 or directly. In some examples, the communication interface(s) 116 can facilitate communication via Web sockets, Application Programming Interfaces (APIs) (e.g., using API calls), HyperText Transfer Protocols (HTTPs), etc.

The server(s) 102 can further be equipped with various input/output devices 118 (e.g., I/O devices). Such I/O devices 118 can include a display, various user interface controls (e.g., buttons, joystick, keyboard, mouse, touch screen, etc.), audio speakers, connection ports and so forth.

In at least one example, the user computing device 104 can include one or more processors 130, computer-readable media 132, one or more communication interfaces 134, and input/output devices 136.

In at least one example, each processor of the processor(s) 130 can be a single processing unit or multiple processing units, and can include single or multiple computing units or multiple processing cores. The processor(s) 130 can comprise any of the types of processors described above with reference to the processor(s) 112 and can be the same as or different from the processor(s) 112.

The computer-readable media 132 can comprise any of the types of computer-readable media 132 described above with reference to the computer-readable media 114 and can be the same as or different from the computer-readable media 114. Functional components stored in the computer-readable media can optionally include at least one application 138 and an operating system 140.

In at least one example, the application 138 can be a mobile application, a web application, or a desktop application, which can be provided by the communication platform or which can be an otherwise dedicated application. In some examples, individual user computing devices associated with the system 100 can have an instance or versioned instance of the application 138, which can be downloaded from an application store, accessible via the Internet, or otherwise executable by the processor(s) 130 to perform operations as described herein. That is, the application 138 can be an access point, enabling the user computing device 104 to interact with the server(s) 102 to access and/or use communication services available via the communication platform. In at least one example, the application 138 can facilitate the exchange of data between and among various other user computing devices, for example via the server(s) 102. In at least one example, the application 138 can present user interfaces, as described herein. In at least one example, a user can interact with the user interfaces via touch input, keyboard input, mouse input, spoken input, or any other type of input. In some examples, user interfaces, as described herein, and/or other operations can be performed via a web browser or other access mechanism.

A non-limiting example of a user interface 142 is shown in FIG. 1. As illustrated in FIG. 1, the user interface 142 can present data associated with one or more communication channels, one or more direct messaging instances, one or more organization administration functions, and in some examples, one or more workspaces. That is, in some examples, the user interface 142 can integrate data from multiple workspaces and associated with multiple functionalities of the application 138 into a single user interface so that the user (e.g., of the user computing device 104) can access and/or interact with data associated with the communication platform. In some examples, the user interface 142 can include a first region 144, or pane, that includes indicator(s) (e.g., user interface element(s) or object(s)) associated with communication channels, direct messaging instances, and/or workspace(s) with which the user (e.g., account of the user) is associated. In some examples, the first region 144 can additionally include an organization administration indicator 146 associated with an organization. In such examples, the organization administration indicator 146 can enable an owner or administrator 148 to perform one or more administrative functions 150 associated with an organization account (e.g., group-based communication account) of an organization.

In various examples, responsive to receiving an indication of selection of the organization administration indicator 146, the application 138 and/or server 102 can cause an organization administration page 152 to surface in a second region 154, or pane. The organization administration page 152 can include one or more administrative functions 150 associated with managing a group-based communication account of an organization. In various examples, the organization administration page 152 can be available to an owner or administrator 148 of the group-based communication account of the organization. In such examples, other instances of the application 138 and/or user interface 142 associated with the organization may not include the organization administration page 152 and/or the organization administration indicator 146.

As illustrated in FIG. 1, the organization administration page 152 can include one or more administrative functions 150. The administrative functions 150 can include settings, permissions, organization data retention including object retention and deleted object retention, management of members, channels, workspaces, configuring access and security, and exporting data associated with the group-based communication account of the organization. As a non-limiting example, the settings and permissions can include managing how users join the account, managing shared channel permissions, establishing organizational policies, setting channel management tools and/or preferences, defining one or more default settings (e.g., do not disturb hours, channels for new users, languages of a workspace or organization, etc.), or the like. As a non-limiting example, management of members, channels, and workspaces can include customizations (e.g., user profiles, workspaces, display names, managing duplicate users, channels, etc.), inviting new users to a workspace, deactivate or reactivate a user account, or the like. As a non-limiting example, a configuration of access and security can include setting default sign-ins for users, user authentication, guest invitation permissions, reset of single sign-on sessions, modifying a single sign-on provider, establishing security and data policies for shared channels, direct messaging instances, and/or workspaces, and the like.

As shown in FIG. 1, the administrative functions 150 can include organization data retention and exporting data. In some examples, the organization data retention can enable the administrator 148 to set a deleted data retention rule for the organization. In some examples, the organization deleted data retention rule can include a default setting for retention of deleted data (e.g., messages, objects, etc.) associated with an organization. In some examples, the deleted data retention default setting can include storing data 126 associated with the organization in perpetuity. In such an example, the messages and/or objects associated therewith (e.g., files, transcripts, reaction emojis, etc.) can be stored in the database 124 for as long as the organizational account exists (and/or forever) and/or unless otherwise deleted or purged, such as via an administrative function 150. In some examples, the default setting can include storing deleted data for a period of time (e.g., 4 years, 7 years, etc.).

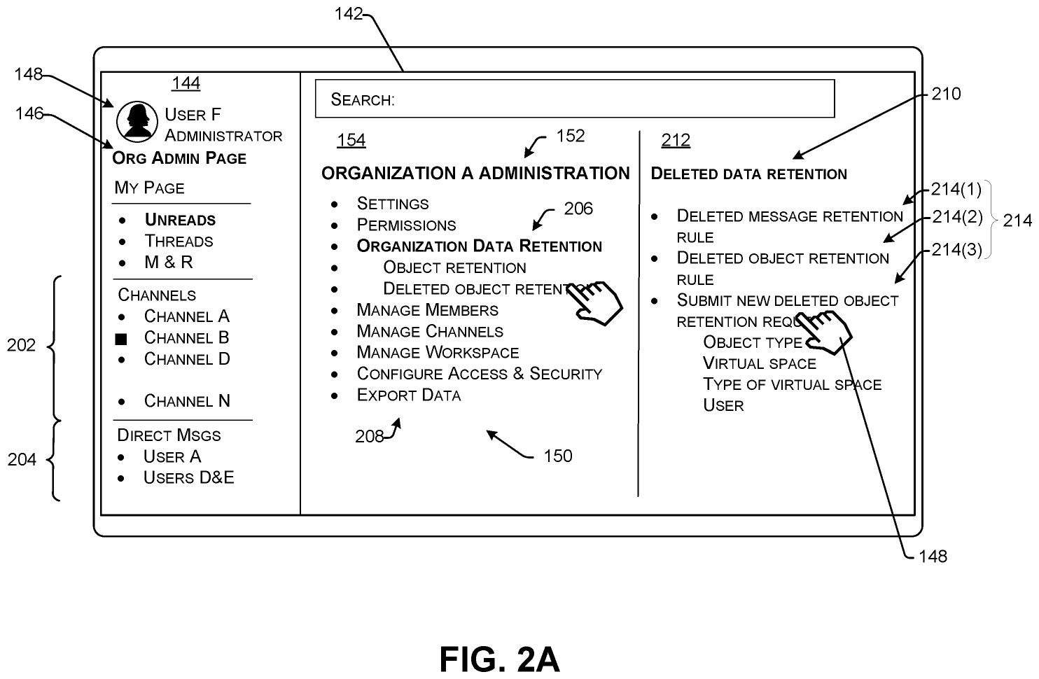

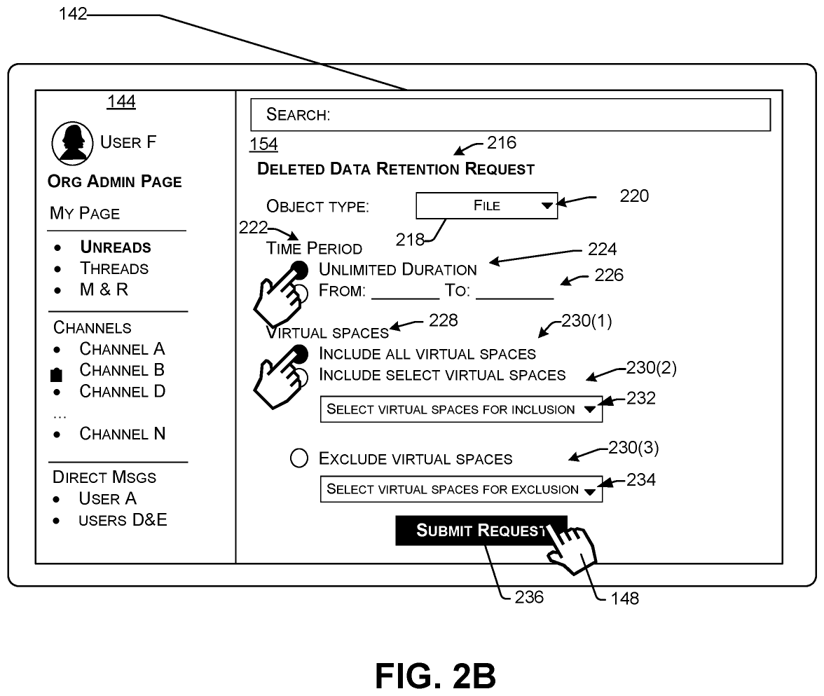

As will be discussed in greater detail below with regard to FIGS. 2A and 2B, the administrative functions 150 associated with organization deleted data retention can enable the administrator 148 to specify a time period to retain deleted objects of a particular type, previously made available via a particular virtual space and/or type of virtual space, in lieu of merely deleting the objects from the database 124. In some examples, the time period can be the same or different from another time period associated with a data retention rule for the organization, such as that associated with storing messages and other data presented in association with the communication platform.

As shown in FIG. 1, the administrative functions 150 can include exporting data. In some examples, the administrative function 150 associated with exporting data can enable the administrator 148 to export data associated with one or more deleted data retention rules. Responsive to receiving a request to export data associated with a deleted data retention rule, the data retention component 120 can identify one or more deleted objects associated with the deleted data retention rule and can send a report including the one or more deleted objects to the user computing device 104 associated with the administrator 148. Additionally or in the alternative, the export data administrative function can enable the administrator 148 to submit an authorization for a third-party service provider 108 to export data 126, including deleted objects stored in the database 124. In some examples, the authorization can include a token or other type of authorization code (e.g., access code) to be provided to the third-party computing device 106, such as to authenticate a subsequent request for the data 126.

In various examples, the user interface 142 can present the messages in the second region 154, such as in a messaging page. In some examples, the messaging page can be presented in lieu of the organization administration page 152. The messaging page can be associated with a data feed (or, “feed”) indicating messages posted to and/or actions taken with respect to one or more virtual spaces for facilitating communications (e.g., a communication channel, direct messaging instance, a board, an audio or video conversation, etc.), or the like. That is, in some examples, the user interface 142 can present messages sent via one or more communication channels and/or via direct message(s) in a single user interface so that the user (e.g., of the user computing device 104) can access and/or interact with data associated with the multiple channels, direct messaging instances, and/or workspaces that he or she is associated with and/or otherwise communicate with other users associated with the multiple channels, direct messaging instances and/or workspaces. In various examples, the messaging page can enable a user to compose, send, receive, and/or view messages and data associated therewith. In at least one example, the messaging page can enable a user to delete an object and/or a message associated therewith, from presentation via the user interface 142. In such an example, in response to receiving the request to delete the object and/or the message, the application 138 can remove the object and/or the message from presentation via user interfaces 142 associated with members of an associated virtual space.

A virtual space can be “public,” which can allow any user within an organization (e.g., associated with an organization identifier to join and participate in the data sharing through the communication channel, or a virtual space may be “private,” which may restrict data communication channel to certain users or users having particular roles (e.g., managers, administrators, etc.). In some examples, a virtual space may be “shared,” which may allow users associated with different organizations (e.g., entities associated with different organization identifiers) to join and participate in the data sharing through the virtual space. Shared virtual spaces may be public, such that they are accessible to any user of either organization, or they may be private, such that they are restricted to access by certain users or users having particular roles from both organizations.

In at least one example, the operating system 140 can manage the processor(s) 130, computer-readable media 132, hardware, software, etc. of the server(s) 102.

The communication interface(s) 134 can include one or more interfaces and hardware components for enabling communication with various other devices (e.g., the user computing device 104), such as over the network(s) 110 or directly. In some examples, the communication interface(s) 134 can facilitate communication via Websockets, APIs (e.g., using API calls), HTTPs, etc.

The user computing device 104 can further be equipped with various input/output devices 136 (e.g., I/O devices). Such I/O devices 136 can include a display, various user interface controls (e.g., buttons, joystick, keyboard, mouse, touch screen, etc.), audio speakers, connection ports and so forth.

While techniques described herein are described as being performed by the data retention component 120, and the application 138, techniques described herein can be performed by any other component, or combination of components, which can be associated with the server(s) 102, the user computing device 104, or a combination thereof.

FIGS. 2A and 2B illustrate example user interfaces for specifying a deleted data retention rule associated with a deleted object, as described herein. FIG. 2A illustrates additional details associated with the user interface 142 that presents data associated with an administration of an account of an organization, as described above with reference to FIG. 1.

As described above, in at least one example, the user interface 142 can include a first region 144, or pane, that includes indicator(s) (e.g., user interface element(s) or object(s)) of workspace(s) with which the user (e.g., account of the user) is associated. As illustrated in FIG. 2A, the user 148 (e.g., User F) can be an administrator of the account of the organization. In such an example, the user 148 can be the user designated to manage the account of the organization. Based on the designation as the administrator 148, the first region 144 can include an organization administration indicator 146.

Additionally or alternatively, the first region 144 can include one or more first virtual space indicators 202, one or more second virtual space indicators 204, and the like. The virtual space indicators 202 and 204 can be associated with respective types of virtual spaces, such as communication channels, direct messaging instances, audio and/or video conversations, boards, stories or clips, and/or other types of virtual spaces provided by the communication platform. In some examples, the first virtual space indicator(s) 202 and/or second virtual space indicators 204 can be grouped based on one or more workspaces associated therewith. In various examples, the virtual spaces associated with the first virtual space indicator(s) 202 and/or the second virtual space indicator(s) 204 can be associated with a same organization (e.g., associated with a same organization identifier). In some examples, one or more of the virtual space(s) can be associated with users of different organizations (e.g., users that are associated with different organization identifiers). In some examples, a first virtual space can be associated with users from a single organization (e.g., associated with a same organization identifier) and a second virtual space can be associated with users from two or more different organizations (e.g., associated with different organization identifiers). Though illustrated in FIG. 2A as the first virtual space indicators 202 being associated with communication channels and the second virtual space indicators 204 being associated with direct messaging instances, this is not intended to be so limiting, and the virtual space indicators 202 and 204 can be associated with additional or alternative types of virtual spaces provided by the communication platform and/or managed by the user 148 (e.g., administrator).

In various examples, the user 148 can navigate between the virtual spaces via the respective first virtual space indicator(s) 202 and/or second virtual space indicator(s) 204, presented in the first region 144. In at least one example, the user can navigate to an organization administration page 152 via the organization administration indicator 146. In such an example, a user account of the user 148 (e.g., User) can be associated with managing a group-based communication account of the organization. Non-limiting examples of the indicators described herein (e.g., first virtual space indicator(s) 202, second virtual space indicator(s) 204, and/or organization administration indicator 146) can include icons, symbols, links, tabs, or other user interface elements or objects. In some examples, such indicators can be associated with actuation mechanisms to enable the user 148 to select an indicator and transition to another page associated with the respective indicator (e.g., page associated with a particular channel, organization administration page 152, etc.). In some examples, a visual indicator can indicate which page a user is currently interacting with and/or has most recently interacted with. For example, the organization administration indicator 146 is outlined in a heavier weight than other first virtual space indicators 202 and/or second virtual space indicator(s) 204, thereby indicating that the user 148 is currently interacting with the organization administration page 152.

As illustrated in FIG. 2A, the organization administration page 152 can include one or more administrative functions 150 associated with managing the group-based communication account of the organization. The administrative functions 150 can include establishing or modifying settings, permissions, organization data retention including object retention and deleted object retention, management of members, channels, workspaces, configuring access and security, and exporting data associated with the group-based communication account of the organization. As a non-limiting example, the settings and permissions may include managing how users join the account, managing shared channel permissions, establishing organizational policies, setting channel management tools and/or preferences, defining one or more default settings (e.g., do not disturb hours, channels for new users, languages of a workspace or organization, etc.), or the like. As a non-limiting example, management of members, channels, and workspaces may include customizations (e.g., user profiles, workspaces, display names, managing duplicate users, channels, etc.), inviting new users to a workspace, deactivate or reactivate a user account, or the like. As a non-limiting example, a configuration of access and security can include setting default sign-ins for users, user authentication, guest invitation permissions, reset of single sign-on sessions, modifying a single sign-on provider, establishing security and data policies for shared channels, direct messaging instances, and/or workspaces, and the like.

As illustrated in FIG. 2A, the administrative functions 150 can include an organization data retention indicator 206 and an exporting data indicator 208. In some examples, the exporting data indicator 208 can enable the administrator 148 to export data associated with an organization and/or enable a third-party service provider 108 permission to export data, as described above. In some examples, the exporting data indicator 208 can enable the administrator 148 to export data and/or enable the third-party service provider 108 to export data associated with one or more deleted data retention rules. Responsive to receiving a request to export data associated with a deleted data retention rule, the communication platform (e.g., data retention component 120) can identify one or more objects with an indicator that provides an indication that the objects were previously deleted by a user of the organization. The communication platform can generate and send a report including the object(s) (e.g., deleted objects) for presentation via the user interface 142. Though described primarily as exporting deleted objects, this is not intended to be so limiting and the export can additionally or alternatively include communications (e.g., messages) and/or other data transmitted via one or more virtual spaces of the communication platform.

In various examples, the organization data retention indicator 206 can enable the user 148 (e.g., administrative user, administrator) to set and/or establish a deleted data retention rule associated with objects transmitted or otherwise available via the communication platform. In such examples, the deleted data retention rule can comprise a period of time for storing objects associated with the deleted data retention rule after a deletion thereof from one or more virtual spaces associated with the organization. In various examples, responsive to receiving an indication of selection of the organization data retention indicator 206, the communication platform can cause a deleted data retention page 210 to be presented to the user 148, such as to manage the retention of data that is deleted in association with the group-based communication account of the organization. In some examples, the deleted data retention page 210 can be presented in a third region 212. In other examples, the deleted data retention page 210 can be presented in the second region 154, such as in lieu of the organization administration page 152.

As illustrated in FIG. 2A, the deleted data retention page 210 can include one or more deleted data retention options 214. The deleted data retention option(s) 214 can represent one or more actions the user 148 can take with respect to the retention of deleted data associated with the group-based communication account. In the illustrative example, the deleted data retention page 210 includes three deleted data retention option(s) 214. However, this is not intended to be so limiting, and the deleted data retention page 210 can include a greater or lesser number of deleted data retention options 214.

In various examples, the deleted data retention page 210 can include a first deleted data retention option 214(1) for managing a deleted data retention rule associated with messages transmitted via the communication platform in association with an organization, and subsequently deleted (e.g., deleted messages). In various examples, the first deleted data retention option 214(1) can enable the user 148 to establish a deleted data retention rule associated with the deleted messages. In such examples, the deleted data retention rule can include an instruction for the communication platform to store deleted messages according to a retention period, such as utilizing the techniques described in U.S. patent application Ser. No. 16/948,299, incorporated herein by reference above. In various examples, the messages and data associated therewith can be stored in association with the deleted data retention rule for messages. That is, messages (e.g., text and/or audio communication, etc.) and objects transmitted in association with messages can be stored after a deletion thereof, for the corresponding retention period.

In various examples, the first deleted data retention option 214(1) can enable the user 148 to establish and/or update the deleted data retention rule associated with messages and/or the data associated therewith. In some examples, the deleted data retention page 210 can include a second deleted data retention option 214(2) for managing a deleted data retention rule associated with deleted objects (e.g., objects transmitted or otherwise made available for viewing via a virtual space, and subsequently deleted). In at least one example, the second deleted data retention option 214(2) can enable the user 148 to establish a deleted data retention rule with respect to deleted objects that is separate and apart from the deleted data retention rule associated with messages. That is, the second deleted data retention option 214(2) can enable the user 148 to cause objects to be stored in a database 124 of the organization after a deletion thereof from a virtual space, regardless of a status of a message with which the object was transmitted. For example, the communication platform can receive a first request to delete an object transmitted in association with a message, without receiving a second request to delete the message. In response to the first request, the communication platform can remove the object from an interface associated with the message, while continuing to cause a presentation of the message via the interface. The communication platform can determine that the object is subject to a deleted data retention rule, and based on the deleted data retention rule, can associate an indicator with the object and continue to store the object in the database 124 based on the indicator. For another example, a message with an associated object can be deleted from a virtual space. The communication platform can receive the indication of deletion and can identify a first deleted data retention rule associated with messages and a second deleted data retention rule associated with objects. The communication platform can cause the message to be stored according to the first deleted data retention rule and the object that was transmitted in association with the message according to the second deleted data retention rule.

As discussed above, the data retention page 210 can include the third deleted data retention option 214(3) for submitting new deleted data retention requests associated with the organization. In some examples, the third deleted data retention option 214(3) can enable the user 148 to submit one or more requests to specify a deleted data retention rule associated with deleted objects. In some examples, the request(s) can specify characteristics associated with the objects to be retained in the database 124, such as an object type, a virtual space associated with the object, a type of virtual space associated with the object, and/or a user associated with uploading and/or deleting the object.

In various examples, the user can select the third deleted data retention option 214(3) for generating a new deleted data retention request associated with an organization. As illustrated in FIG. 2B, responsive to receiving the indication of selection, the communication platform causes a deleted data retention request submission page 216 to be presented via the user interface 142. In some examples, the deleted data retention request submission page 216 can be presented in the second region 154. In some examples, the deleted data retention request submission page 216 can be presented in the third region 212, such as in lieu of the deleted data retention page 210.

In some examples, the user 148 can submit a request to specify a new deleted data retention rule associated with one or more objects. In some examples, the deleted data request submission page 216 can include an object type input 218, to enable the user 148 to specify an object type associated with the new deleted data retention rule. The object type input 218 can be configured to enable a user to type or orally enter an object type for association with the new deleted data retention rule. In some examples, the object type input 218 can include a drop down menu selection 220 to enable the user to select a particular object type from a list of object types available for association with the new deleted data retention rule.

In the absence of receiving an input via the object type input 218, the communication platform can apply the new deleted data retention rule to all types of objects and/or messages that are presented via the communication platform and subsequently deleted. Based on receiving an input via the object type input 218, the communication platform can apply the new deleted data retention rule to the particular object type. For example, in response to receiving an input to retain deleted files, the communication platform can cause an indicator to be associated with deleted files that were previously transmitted and/or uploaded directly to a virtual space associated with the organization of the user 148. Though illustrated as a single object type selected in the object type input 218, this is not intended to be limiting, and two or more object types may be selected via the object type input 218. In such examples, the two or more object types can be associated with the new deleted data retention rule.

In various examples, the new deleted data retention rule can include a default time period of unlimited duration (e.g., store data associated with the deleted data retention rule in perpetuity). In such examples, the communication platform can store objects of the selected object type(s) (e.g., object type(s) input in the object type input 218) until the communication platform receives an indication of cancellation or deletion of the deleted data retention rule. In various examples, the deleted data retention request submission page 216 can include a time period input section 222 via which the user 148 can designate a time period (e.g., retention period) associated with the new deleted data retention rule. The time period input section 222 can include an unlimited duration selection 224 and/or a date input section 226. In various examples, the user 148 can select the unlimited duration selection 224 to cause the communication platform to store deleted objects of the selected object type(s) until the deleted data retention rule is cancelled or deleted.

In some examples, the user 148 can select the date input section 226 to establish a defined time period associated with the new deleted data retention rule. In the illustrative example, the date input section 226 includes a date range, such as with a from (or beginning date) date and a to (or ending) date. In some examples, the date input section 226 can include the ending date. In such examples, the communication platform can store deleted objects associated with the new deleted data retention rule from a time of request submission and/or processing to the ending date. In various examples, responsive to determining that a current date is on or after the ending date, the communication platform can automatically cancel or delete the deleted data retention rule. In such examples, the communication platform may cease associating an indicator with deleted objects associated with the deleted data retention rule. In some examples, responsive to determining that a current date is on or after the ending date, the communication platform may delete or otherwise purge the deleted objects that were previously stored in association with the deleted data retention rule. In some examples, responsive to determining that a current date is on or after the ending date, the communication platform can generate a report including the deleted objects associated with the deleted data retention rule. In such examples, the communication platform can store the report in a database 124. In some examples, the report may be accessible to the user 148, such as via a data export.

In various examples, the deleted data retention request submission page 216 can include a virtual space input section 228 through which the user 148 can specify virtual spaces to include and/or exclude from the new deleted data retention rule. In some examples, the virtual space input section 228 can include a first option 230(1) to include all virtual spaces associated with the organization. In such examples, the communication platform can store deleted objects transmitted or otherwise made available via any virtual space associated with the organization.

In some examples, the user 148 can select particular virtual spaces and/or types of virtual spaces (e.g., workspaces, communication channels, direct messaging instances, boards, audio and/or video conversations, etc.) to apply to the new deleted data retention rule. In such examples, the virtual space input section 228 can include a second option 230(2) to select the virtual spaces (and/or types of virtual spaces) for inclusion with the new deleted data retention rule. For example, the user 148 can input communication channels via the second option 230(2), to cause the new deleted data retention rule to store deleted objects that are associated with communication channels. In some examples, the second option 230(2) can include a drop down menu 232 that is selectable to cause a presentation of a list of virtual spaces and/or types of virtual spaces that are configured for association with the new deleted data retention rule. In at least one example, a communication platform can identify virtual spaces to include in the list based on a type of object provided in the object type input 218.

Additionally or in the alternative, the virtual space input section 228 can include a third option 230(3) configured to enable a selection of virtual spaces and/or types thereof for exclusion from the new deleted data retention rule. In some examples, the third option 230(3) can include a drop down menu 234 that is selectable to cause a presentation of the list of virtual spaces and/or types of virtual spaces that are configured for dissociation from the new deleted data retention rule. Continuing the example from above in which the user 148 selects a virtual space type of communication channels to associate with the new deleted data retention rule, the third option 230(3) can further enable the user 148 to exclude one or more particular communication channels from the new deleted data retention rule, such as those associated with personal (e.g., non-work related) conversations between users. In at least one example, the communication platform can determine virtual spaces to include in the list based at least in part on input provided via the object type input 218 and/or the second option 230(2).

As illustrated in FIG. 2B, the deleted data retention request submission page 216 can include a submission selectable control 236 via which the user 148 can submit the request to generate the new deleted data retention rule associated with deleted objects. In various examples, responsive to receiving an indication of selection of the submission selectable control 236, the communication platform can generate an instruction to associate an indicator with select objects associated with the request (e.g., objects associated with the object type presented in association with selected (not excluded) virtual spaces, such as via the second option 230(2), the third option 230(3), and/or the like). As discussed above, the communication platform can store the deleted objects with the associated indicator for the time period indicated in the time period input section 222. In other words, based on the new deleted data retention rule, the communication platform can continue to store deleted objects for the time period in a database that would otherwise be deleted therefrom.

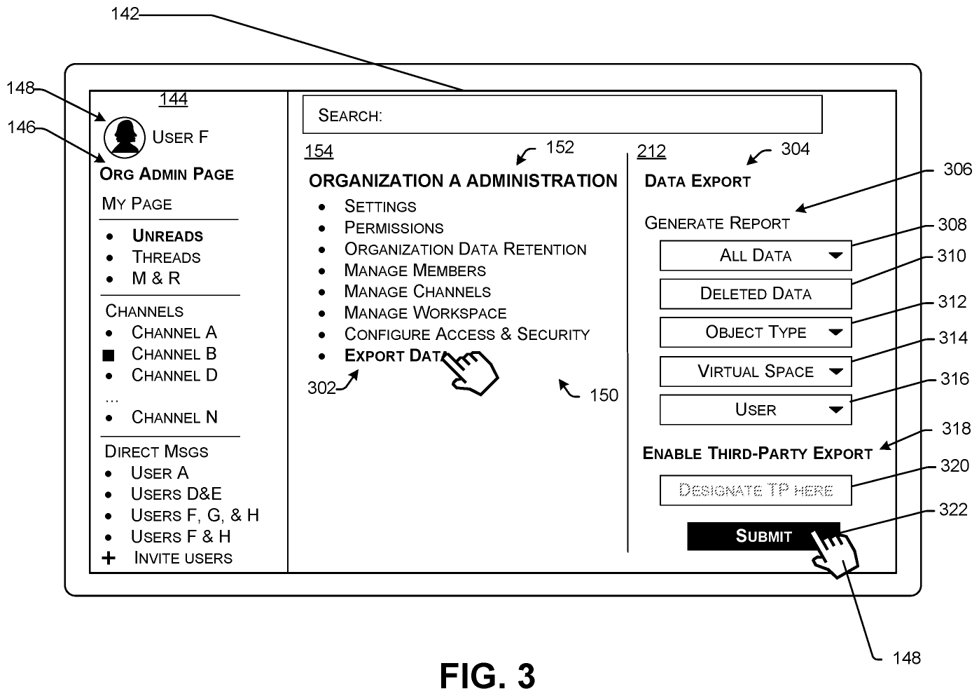

FIG. 3 illustrates an example user interface for viewing deleted objects stored based on a deleted data retention rule. As described above, in at least one example, the user interface 142 can include a first region 144, or pane, that includes indicators of workspaces, channels, and/or direct messaging instances with which the user 148 is associated. The user 148 can include an administrator of a group-based communication account of an organization. As such, the user 148 can be the user designated to manage the account of the organization. Based on a designation as the administrator 148, the first region can include an organization administration indicator 146.

As discussed above, responsive to receiving an indication of selection of the organization administration indicator 146, the user interface 142 can present the organization administration page 152 in a second region 154, or pane. In various examples, the organization administration page 152 can include one or more administrative functions 150 associated with managing the group-based communication account of the organization. As a non-limiting example, the organization administration page 152 can include options to establish or modify settings, permissions, organization data retention including deleted data retention, management of members, channels, workspaces, configuring access and security, and export data associated with the group-based communication account of the organization. In at least one example, the administrative function(s) 150 can include an export data indicator 302, such as export data indicator 208 of FIG. 2A.

In various examples, responsive to receiving an indication of selection of the export data indicator 302, the communication platform can cause a data export page 304 to be presented via the user interface 142. In the illustrative example, the data export page 304 is presented via the third region 212 or pane. In other examples, the data export page 304 can be presented via the second region 154, such as in lieu of the organization administration page 152.

In various examples, the data export page 304 can include a report generation menu 306 via which the user 148 can generate a report including deleted objects associated with a deleted data retention rule. In various example, the report generation menu 306 can include an all data selection option 308 configured to enable the user 148 to generate a report including all stored data associated with an organization, including deleted data. In some examples, the report can include a bifurcated report, with a first section associated with non-deleted data and a second section associated with deleted data. In at least one example, the all data selection option 308 can include a drop down menu to enable the user to select a particular type of data to be presented in the report. For example, the user 148 can utilize the drop-down menu to generate a report associated with all files that are stored in association with the organization, both deleted and non-deleted files.

In some examples, the report generation menu 306 can include a deleted data selectable control 310 enabling the user 148 to generate a report including deleted data stored in association with the organization. In such examples, the deleted data can include messages and/or objects that are stored in association with a deleted data retention rule. In various examples, the user 148 can further refine the report by inputting a particular object type to be included in the report via an object type input 312. In such examples, the communication platform can identify deleted objects of the particular type(s) designated in the object type input 312 for inclusion in the report. In some examples, the object type input 312 can be configured to receive a typed or orally input list of one or more object types. In some examples, the one or more object types can be accessible via a drop-down menu.

In various examples, the user 148 can further refine the report by inputting a virtual space or type thereof associated with deleted objects to be included in the report via a virtual space input 314. Similar to the discussion above with regard to the object type input 312, the virtual space input 314 can be configured to receive a typed or orally input list of one or more virtual spaces via which deleted objects were transmitted or otherwise made available via the communication platform prior to a deletion thereof. In some examples, the one or more virtual spaces can be accessible via a drop-down menu associated with the virtual space input 314.

Additionally or alternatively, the report generation menu 306 can include a user selectable option 316, enabling the user 148 to export data (deleted and/or non-deleted data) transmitted via the communication platform in association with a particular user. For example, the user 148 can submit a request to generate a report associated with objects deleted by a particular user. In response to receiving the request, the communication platform can identify the deleted objects that are associated with a particular user identifier of the user. For another example, the user 148 can submit a request to generate a report associated with deleted objects that were published, uploaded, or otherwise made available via the communication platform by a particular user. In response to receiving the request, the communication platform can identify the deleted objects that were published, uploaded, or otherwise made available by the user.

In various examples, the data export page 304 can include a third-party permissions section 318 in which the user 148 can authorize a third-party service provider, such as third-party service provider 108 with permissions to access data stored in association with the organization. In various examples, the third-party service provider can include an electronic discovery service provider configured to identify, collect, and provide electronic data in response to a request for production, such as in association with a legal proceeding.

In various examples, in response to receiving an input (e.g., name, identifier, link to web site or application, etc. of the third-party service provider) via a third-party input 320, the communication platform can generate a token, access code, or other authorization or verification code to provide to a third-party service provider. At a later time, the third-party service provider can submit a request for data (e.g., API call) including the token, access code, or other authorization or verification code. The communication platform can verify authenticity of the request from the third-party service provider based on the token or other verification code associated with the request. Based on a verification of the request, the communication platform can identify the requested data and provide the data to the third-party service provider.

In various examples, the data export page 304 can include an export submission option 322. In some examples, responsive to receiving an indication of selection of the export submission option 322, the communication platform can generate the report based on the user input via the report generation menu 306. In various examples, the communication platform can cause the report to be presented via the user interface 142, such as in the second region 154 or the third region 212. Additionally or alternatively, responsive to receiving an indication of selection of the export submission option 322, the communication platform can enable a third-party service provider access to data (e.g., deleted data and/or non-deleted data) stored in association with the organization of the user 148.

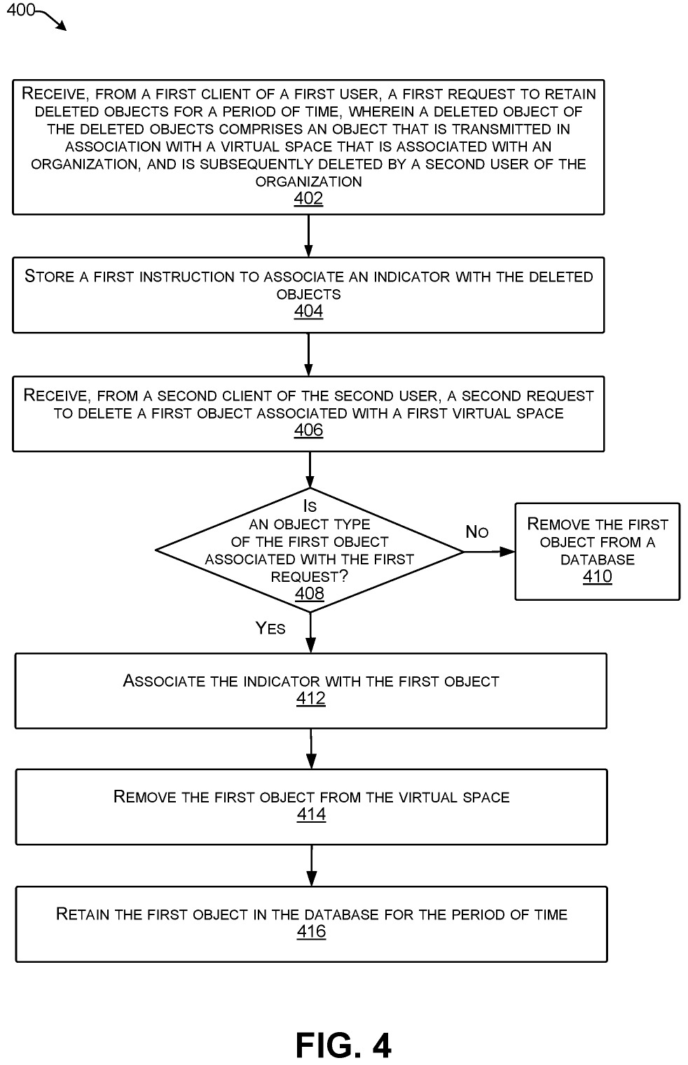

FIGS. 4-7 illustrate example processes in accordance with embodiments of the disclosure. These processes are illustrated as logical flow graphs, each operation of which represents a sequence of operations that may be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations may be combined in any order and/or in parallel to implement the processes.

FIG. 4 illustrates an example process 400 for storing data based on a deleted data retention rule, as described herein. In some examples, example process 400 may be carried out by communication platform server(s) 102, although in some examples user computing device(s) 104 may provide or receive at least some of the data and instructions discussed and/or may perform one or more of the operations instances where the processing is partially or completely distributed to user computing devices.

At operation 402, the communication platform receives, from a first client of a first user, a first request to retain deleted objects for a period of time, wherein a deleted object of the deleted objects includes an object that is transmitted in association with a virtual space of the communication platform that is associated with an organization and is subsequently deleted by a second user of the organization. As discussed above, the first user can include an administrative user that is associated with the organization. That is, the first user can have administrative permissions and/or an account associated with the first user can be configured to perform administrative functions, such as administrative functions 150. In various examples, the first user can submit the first request via an organization administration page 152, such as that described with respect to FIGS. 2A-3. In some examples, the communication platform can receive the first request via a deleted data retention request submission page, such as deleted data retention request submission page 216.

As discussed above, the object can include a file (e.g., documents, video files, audio files, etc.), transcripts (e.g., textual representation of audio conversations or clips, video conversations or clips, etc.), reaction emojis, and/or the like that are transmitted and/or otherwise made available via the virtual space. For example, an object can be transmitted via the virtual space in association with a message, such as a document attached to a message. For another example, the object can be uploaded directly to the virtual space, such as to enable members of the virtual space to access the object. As discussed above, the first request can include an object type, a virtual space, and/or a type of virtual space for association with a deleted data retention rule. The first request can also include period of time (e.g., store indefinitely, store for 1 year, 7 years, etc.), for association with the deleted data retention rule. As such, the first request can include a request for the communication platform to continue to store one or more particular types of deleted objects transmitted and/or made available via the communication platform for a designated period of time.

In various examples, the object can be transmitted and/or made available via one or more virtual spaces. In such examples, the communication platform can associate the object with the virtual space(s) and vice versa. For example, a user can upload a document to a plurality of communication channels at a single time. In response to the upload, an object identifier of the document can be associated with the communication channels and virtual space identifiers associated with each of the plurality of communication channels can be associated with the document. As discussed above, the virtual spaces can include any type of virtual space available via the communication platform, such as a workspaces, communication channels, direct messaging instances, boards, audio and/or video conversations, and the like.

At operation 404, the communication platform stores a first instruction to associate an indicator with the deleted objects. The indicator can include a flag, binary code, or other type of indicator to signal that the object is subject to a deleted data retention rule. The indicator can provide an indication to not delete (e.g., do not remove from the database) the associated object.

At operation 406, the communication platform receives, from a second client of the second user, a second request to delete a first object associated with a first virtual space. In some examples, the communication platform receives the second request via an interface associated with the first virtual space. For example, the second user can right click on an indicator associated with the first object presented via the interface to surface a menu of options associated with the first object, the menu of options including a “delete object” option. In response to receiving an indication of selection of the “delete object” option, the communication platform can receive the second request to delete the first object.

At operation 408, the communication platform determines whether an object type of the first object is associated with the first request. In some examples, the communication platform determines the object type of the first object based on metadata associated with the first object. For example, the first object can include a link stored in metadata, linking the first object to a third-party computing device. Based on the link, the communication platform can determine that the first object is a third-party document presented via the virtual space. In some examples, the communication platform determines the object type of the first object based on a name or title associated with the first object. For example, the first object can include a title “firstobject.docx.” Based on the title, the communication platform can identify that the first object is a Word® document, or file.

Based on a determination that the object type of the first object is not associated with the first request to retain deleted objects (“No” at operation 408), the communication platform, at operation 410, removes the first object from the database. In some examples, if the first object is not associated with other object types that should be retained from other requests, the first object is removed from the database. A removal can include a hard delete from the database, such that the first object is no longer accessible via the communication platform to any users, including the first user (e.g., administrative user).

Based on a determination that the object type of the first object is associated with the first request to retain deleted objects (“Yes” at operation 408), the communication platform, at operation 412, associates the indicator with the first object. As discussed above, the indicator can provide an indication, to the communication platform, to not delete the first object from the database. The indicator can include a flag or other indication to retain the message for the period of time associated with the deleted data retention rule.

At operation 414, the communication platform removes the first object from the virtual space. In various examples, a removal of the first object from the virtual space can include withholding data associated with the first object from presentation in association with the virtual space. That is, the communication platform can render the first object unavailable for viewing and/or accessing via the virtual space.

At operation 416, the communication platform retains the first object in the database for the period of time. The period of time can include a determined period of time (e.g., finite or infinite) based on the first request.

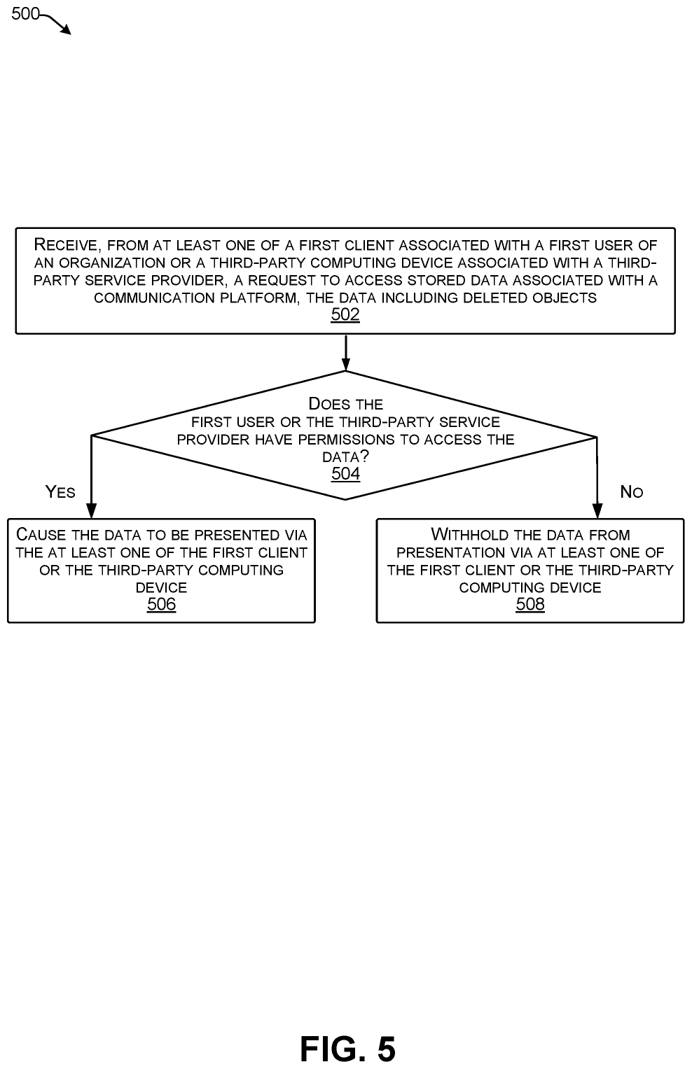

FIG. 5 illustrates an example process 500 for rendering data subject to a deleted data retention rule, as described herein. In some examples, example process 500 may be carried out by communication platform server(s) 102, although in some examples user computing device(s) 104 may provide or receive at least some of the data and instructions discussed and/or may perform one or more of the operations instances where the processing is partially or completely distributed to user computing devices.

At operation 502, the communication platform receives, from at least one of a first client associated with a first user of an organization or a third-party computing device associated with a third-party service provider, a request to access stored data associated with the communication platform, the data including deleted objects. As discussed above, the first user can include an administrative user that is associated with the organization. That is, the first user can have administrative permissions and/or an account associated with the first user can be configured to perform administrative functions, such as administrative functions 150. In various examples, the first user can submit the request to view stored data via an organization administration page 152, such as that described with respect to FIGS. 2A-3. In some examples, the communication platform can receive the request to view data via a data export page, such as data export page 304.

In various examples, the communication platform can receive the request from the third-party computing device associated with the third-party service provider (e.g., third-party computing device 106 associated with third-party service provider 108). In at least one example, the third-party service provider can include an electronic discovery service provider configured to identify, collect, and provide electronic data in response to a request for production, such as in association with a legal proceeding. In various examples, the third-party service provider can include a token, access code, or other authentication code with the request, such as to verify an authenticity of the request to access data. As discussed above, the token, access code, or other authentication code can be generated by the communication platform and provided to the third-party service provider for authentication. In some examples, the token, access code, or other authentication code can be generated by the first user and provided to the third-party service provider by either the first user or the communication platform. For example, the first user can generate a password to enable the third-party service provider access to data stored in association with the organization. The first user can provide the password to the third-party service provider and can store the password in association with the communication platform, such as to enable the communication platform to authenticate the third-party service provider. The third-party service provider can subsequently include the password in the request to access data sent to the communication platform, enabling the communication platform to authenticate the request.

At operation 504, the communication platform determines whether the first user or the third-party service provider have permissions to view the data. In various examples, the communication platform identifies permissions data associated with a first user account of the first user. In some examples, the communication platform determines whether the first user account is an administrative account of the organization. In examples in which the communication platform receives the request from the third-party service provider, the communication platform determines whether a token, access code, or other authentication code is associated with the request and is valid.

Based on a determination that the first user or the third-party service provider have permissions to access the data (“Yes” at operation 504), the communication platform, at operation 506, causes the data to be presented via the at least one of the first client or the third-party computing device. As discussed above, the data can include deleted data subject to one or more deleted data retention rules and non-deleted data stored in association with the organization. In various examples, the communication platform determines that the first user has appropriate permissions to access the data (e.g., the first account of the first user includes an administrative account) and/or the request from the third-party service provider includes an authentic token, access code, or other authentication code (e.g., the request is authenticated).

In various examples, based on a verification and/or authentication of the request, the communication platform can generate a report to send to the at least one of the first client or the third-party computing device. In various examples, the report can include the requested data stored in association with the communication platform. In some examples, the report can include links (e.g., URLs, etc.) to access the data in the database. In some examples, the report can include a bifurcated report with one section including non-deleted data (e.g., data that is available for access and/or presentation via an interface of the communication platform) and a second section including deleted data (e.g., data that has been removed from presentation via the interface but is retained in the database).

Based on a determination that the first user or the third-party service provider do not have permissions to access the data (“No” at operation 504), the communication platform, at operation 508, withholds the data from presentation via the at least one of the first client or the third-party computing device. That is, based on a determination that the first user or the third-party service provider do not have appropriate permissions to access the data, the communication platform does not generate and/or provide the report described above.

In some examples, based on a determination that the first user does not have access permissions to the data (e.g., is not an administrator), the communication platform can cause an error notification to be presented via an interface associated with the first client. In some examples, based on a determination that the third-party service provider does not have access permissions (e.g., request for data does not include an authentic token), the communication platform can send an error message to the third-party computing device indicating that the request for data could not be authenticated.

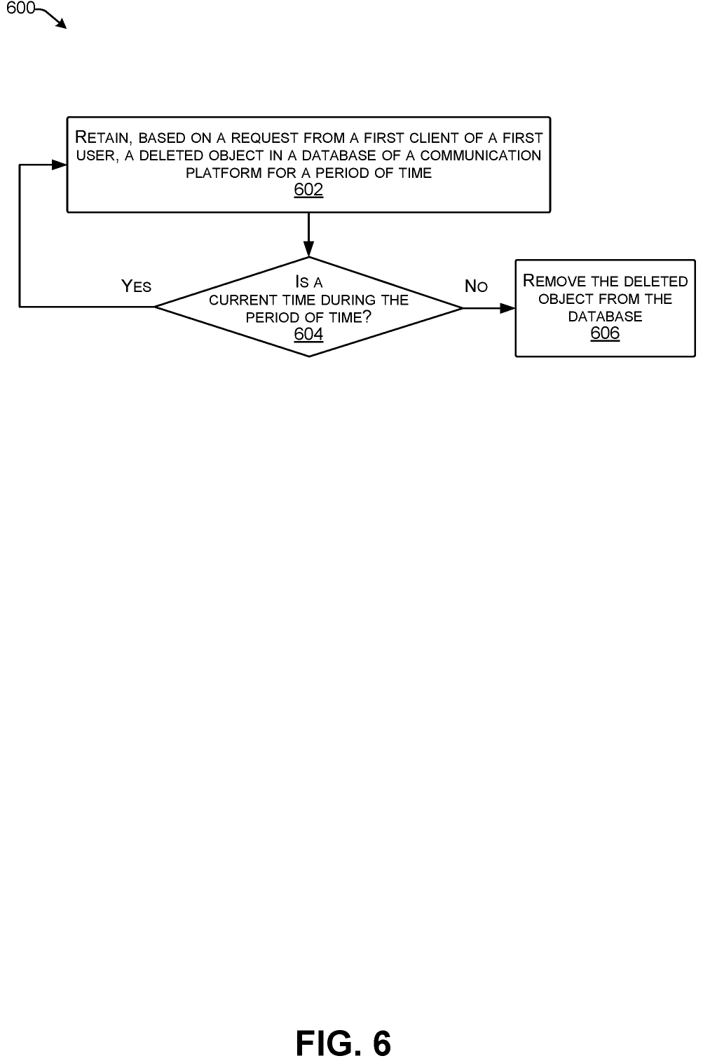

FIG. 6 illustrates another example process 600 for removing a previously deleted object from a database after a time period associated with a deleted data retention rule, as described herein. In some examples, example process 600 may be carried out by communication platform server(s) 102, although in some examples user computing device(s) 104 may provide or receive at least some of the data and instructions discussed and/or may perform one or more of the operations instances where the processing is partially or completely distributed to user computing devices.

At operation 602, the communication platform retains, based on a request from a first client of a first user, a deleted object in a database of a communication platform for a period of time. In various examples, the communication platform can retain the deleted object based on a determination that an indicator (e.g., flag, binary code, etc.) is associated therewith. The deleted object can include an object that is transmitted in association with a virtual space of the communication platform that is associated with an organization and is subsequently deleted from the virtual space. That is, the deleted object includes an object that was previously, but is no longer, available for viewing and/or accessing via the virtual space. The object can include a file (e.g., documents, video files, audio files, etc.), transcripts (e.g., textual representation of audio conversations or clips, video conversations or clips, etc.), reaction emojis, calendar events, workflows, and/or the like that are transmitted and/or otherwise made available via the virtual space.

As discussed above, the communication platform can receive the request for the first client of the first user at a first time. The first user can include an administrative user of the organization, such that a first user account includes one or more administrative functions (e.g., administrative functions 150) associated therewith. The first user can be a request to generate a deleted data retention rule associated with the organization. As such, the request can include an object type, virtual space, virtual space type, and/or a period of time to be associated with the deleted data retention rule. In various examples, the communication platform can retain the deleted object in the database based on a determination that the deleted object is associated with the deleted data retention rule. In such examples, the communication platform retains the deleted object based on a determination that an object type of the deleted object and/or a virtual space (and/or virtual space type) through which the deleted object was previously available are associated with the deleted data retention rule. For example, the communication platform identifies that at least one of the object type or the virtual space characteristics of the deleted object match those designated in the deleted data retention rule.

At operation 604, the communication platform determines whether a current time is during the period of time. The current time can include a time after time associated with deletion of the deleted object. In various examples, the time associated with deletion of the deleted object can be stored as metadata associated with the deleted message. In some examples, the period of time can be measured from the time associated with deletion of the object. In other examples, the period of time can be measured from another time associated with the deleted object, such as a time of transmission or upload of the deleted object to the communication platform, a time of creation of the deleted object, or the like. In such examples, each of the times described can be stored as metadata associated with the deleted object.

Based on a determination that the current time is during the period of time (“Yes” at operation 604), the communication platform continues to retain the deleted object in the database.

Based on a determination that the current time is after the period of time (“No” at operation 604), the communication platform, at operation 606, removes the deleted object from the database. A removal of the deleted object from the database can include a hard deletion. As such, the removal of the deleted object from the database can render the deleted object unavailable for access, such as in a request to export data stored in association with the organization by an administrative user and/or a third-party service provider.

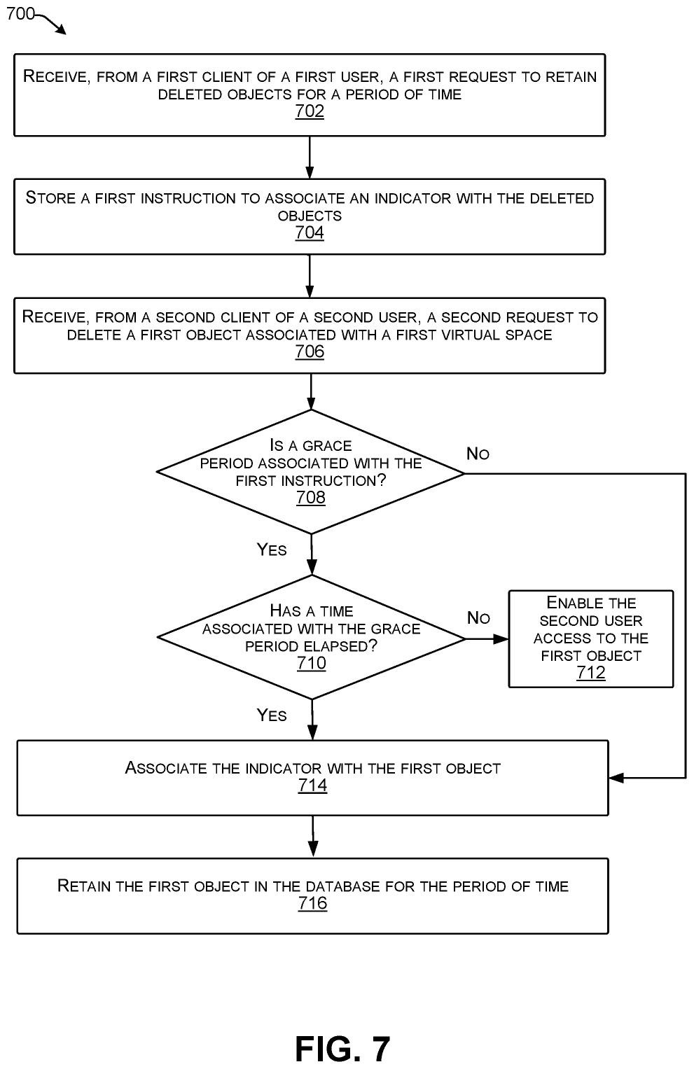

FIG. 7 illustrates an example process 700 for enabling an end user to access a deleted object for a period of time after deletion, as described herein. In some examples, example process 700 may be carried out by communication platform server(s) 102, although in some examples user computing device(s) 104 may provide or receive at least some of the data and instructions discussed and/or may perform one or more of the operations instances where the processing is partially or completely distributed to user computing devices.

At operation 702, the communication platform receives, from a first client of a first user, a first request to retain deleted objects for a period of time. The request to retain deleted objects can include a request to generate a deleted data retention rule associated with one or more objects associated with the communication platform. A deleted object of the deleted objects can include an object that is transmitted in association with a virtual space of the communication platform that is associated with an organization and is subsequently deleted by a second user of the organization. As discussed above, the first user can include an administrative user that is associated with the organization. That is, the first user can have administrative permissions and/or an account associated with the first user can be configured to perform administrative functions, such as administrative functions 150. In various examples, the first user can submit the first request via an organization administration page 152, such as that described with respect to FIGS. 2A-3. In some examples, the communication platform can receive the first request via a deleted data retention request submission page, such as deleted data retention request submission page 216.

As discussed above, the object can include a file (e.g., documents, video files, audio files, etc.), transcripts (e.g., textual representation of audio conversations or clips, video conversations or clips, etc.), reaction emojis, calendar events, workflows, and/or the like that are transmitted and/or otherwise made available via the virtual space. For example, an object can be transmitted via the virtual space in association with a message, such as a document attached to a message. For another example, the object can be uploaded directly to the virtual space, such as to enable members of the virtual space to access the object. As discussed above, the first request can include an object type, a virtual space, and/or a type of virtual space for association with a deleted data retention rule. The first request can also include periods of time (e.g., store indefinitely, store for 1 year, 7 years, etc.), for association with the deleted data retention rule. As such, the first request can include a request for the communication platform to continue to store one or more particular types of deleted objects transmitted and/or made available via the communication platform for a designated period of time.

In various examples, the object can be transmitted and/or made available via one or more virtual spaces. In such examples, the communication platform can associate the object with the virtual space(s) and vice versa. For example, a user can upload a document to a plurality of communication channels at a single time. In response to the upload, an object identifier of the document can be associated with the communication channels and virtual space identifiers associated with each of the plurality of communication channels can be associated with the document. As discussed above, the virtual spaces can include any type of virtual space available via the communication platform, such as a workspaces, communication channels, direct messaging instances, boards, audio and/or video conversations, and the like.

At operation 704, the communication platform stores a first instruction to associate an indicator with the deleted objects. The indicator can include a flag, binary code, or other type of indicator to signal that the object is subject to a deleted data retention rule. The indicator can provide an indication to not delete (e.g., do not remove from the database) the associated object.

At operation 706, the communication platform receives, from a second client of the second user, a second request to delete a first object associated with a first virtual space. In some examples, the communication platform receives the second request via an interface associated with the first virtual space. For example, the second user can right click on an indicator associated with the first object presented via the interface to surface a menu of options associated with the first object, the menu of options including a “delete object” option. In response to receiving an indication of selection of the “delete object” option, the communication platform can receive the second request to delete the first object.

At operation 708, the communication platform determines whether a grace period is associated with the first instruction. The grace period can include a time period (e.g., 5 seconds, 10 seconds, 1 minute, 5 minutes, etc.) in which the second user can reverse the deletion of the object identified in the second request. That is, the communication platform can be configured to enable the second user to retract or otherwise cancel the request to delete the object during the grace period, causing the object to again be available for access and/or viewing via the associated virtual space(s).

Based on a determination that the grace period is associated with the first instruction (“Yes” at operation 708), the communication platform, at operation 710, determines whether the time period associated with the grace period has elapsed. Based on determination that the grace period has not elapsed (“No” at operation 710), the communication platform, at operation 712, enables the second user access to the first object. In some examples, the communication platform can enable an option, via an interface, to undelete the deleted object. In such examples, the second user can submit, via the interface, a third request to retract or otherwise cancel the object deletion request (e.g., cancel the second request and not delete the selected object).

Based on a determination that the grace period is not associated with the first instruction (“No” at operation 708) or that the grace period has elapsed (“Yes” at operation 710), the communication platform, at operation 714, associates the indicator with the first object. As discussed above, the indicator can provide an indication, to the communication platform, to not delete the first object from the database. The indicator can include a flag or other indication to retain the message for the period of time associated with the deleted data retention rule.

At operation 716, the communication platform retains the first object in the database for the period of time. The period of time can include a determined period of time (e.g., finite or infinite) based on the first request. Additionally, the communication platform can remove an indicator associated with the first object and/or can remove the option to undelete the deleted object from the interface. That is, the communication platform can modify the interface to not include an indication of the first object. In some examples, the communication platform can modify the interface to include an indication that the first object has been deleted. In some examples, the indication of deletion can include an identification of a user account associated with the deletion (e.g., the second user).

### Example Clauses

A: A method implemented at least in part by a server computing device associated with a communication platform, the method comprising: receiving, from a first client of a first user of an organization, a first request to retain deleted objects for a period of time, wherein a deleted object of the deleted objects comprises an object that is transmitted in association with a virtual space of the communication platform that is associated with the organization and is subsequently requested to be deleted by a second user of the organization; storing, based at least in part on the first request, a first instruction to associate an indicator with the deleted objects; receiving, from a second client associated with the second user of the organization, a second request to delete a first object associated with a first virtual space; associating the indicator with the first object based at least in part on at least one of the first request and the second request; removing the first object from the first virtual space based at least in part on the second request; and retaining, based at least in part on the first object being associated with the indicator, the first object in a database associated with the communication platform for the period of time.

B: The method of paragraph A, further comprising: receiving, from at least one of the first client or a third-party computing device, a third request to receive stored data associated with the deleted objects; and sending, to the at least one of the first client or the third-party computing device and based at least in part on the third request, data associated with the first object.

C: The method of either paragraph A or paragraph B, wherein the object comprises at least one of: a file; a calendar event; a workflow; a reaction emoji; an audio conversation; a video conversation; or a transcript of a conversation.

D: The method of any one of paragraphs A-C, wherein the first request to retain deleted objects comprises a request to retain a first type of object, the method further comprising: receiving, from a third client associated with a third user of the organization, a third request to delete a second object associated with a second virtual space; determining that the second object comprises a second type of object; and removing the second object from the database based at least in part on a determination that the second object comprises the second type of object different than the first type of object.

E: The method of any one of paragraphs A-D, further comprising: determining that a current time is after an end of the period of time associated with the first object; and removing the first object from the database.

F: The method of any one of paragraphs A-E, wherein the first object is a first type of object and the period of time is a first period of time, the method further comprising: receiving, from the first client, a third request to retain, in association with at least the first virtual space, the first type of object for a second period of time and a second type of object for a third period of time that is shorter than the second period of time; receiving a second object of the second type of object transmitted via the first virtual space, wherein the first object is transmitted in association with the second object; determining that a current time is after an end of the third period of time associated with the second object and before an end of the second period of time associated with the first object; removing the second object from the first virtual space based on a determination that the current time is after the end of the third period of time; and prior to receiving the second request to delete the first object, updating an interface associated with the first virtual space to render the first object accessible via the first virtual space independently of the second object.

G: The method of any one of paragraphs A-F, wherein the first object is accessible in the database to an administrative user account associated with the organization.

H: The method of any one of paragraphs A-G, further comprising: receiving, from the second client after removing the first object from the first virtual space, a third request to access data associated with the first object; determining that the indicator is associated with the first object; and causing a presentation, on an interface of the second client, of a message indicating that the first object is no longer accessible.

I: The method of any one of paragraphs A-H, wherein the period of time is a first period of time, the method further comprising: receiving, from the second client and after a submission of the second request to delete the first object, a third request to access the first object; identifying a second period of time associated with the second user accessing an object after a deletion of the object, the second period of time being shorter than the first period of time; determining that a current time is prior to an end of the second period of time; and causing a presentation, on an interface of the second client, of the first object based at least in part on a determination that the current time is prior to the end of the second period of time.

J: A system comprising: one or more processors; and one or more non-transitory computer readable media storing instructions that, when executed, cause the system to: receive, from a first client of a first user of an organization, a first request to retain deleted objects for a period of time, wherein a deleted object of the deleted objects comprises an object that is transmitted in association with a virtual space of the communication platform that is associated with the organization and is subsequently requested to be deleted by a second user of the organization; store, based at least in part on the first request, a first instruction to associate an indicator with the deleted objects; receive, from a second client associated with the second user of the organization, a second request to delete a first object associated with a first virtual space; associate the indicator with the first object based at least in part on at least one of the first request and the second request; remove the first object from the first virtual space based at least in part on the second request; and retain, based at least in part on the first object being associated with the indicator, the first object in a database associated with the communication platform for the period of time.

K: The system of paragraph J, wherein the instructions further cause the system to: receive, from at least one of the first client or a third-party computing device, a third request to receive stored data associated with the deleted objects; and send, to the at least one of the first client or the third-party computing device and based at least in part on the third request, data associated with the first object.

L: The system of either paragraph J or paragraph K, wherein the object comprises at least one of: a file; a calendar event; a workflow; a reaction emoji; an audio conversation; a video conversation; or a transcript of a conversation.

M: The system of any one of paragraphs J-L, wherein the first request to retain deleted objects comprises a request to retain a first type of object, and the instructions further cause the system to: receive, from a third client associated with a third user of the organization, a third request to delete a second object associated with a second virtual space; determine that the second object comprises a second type of object; and remove the second object from the database based at least in part on a determination that the second object comprises the second type of object different than the first type of object.

N: The system of any one of paragraphs J-M, wherein the instructions further cause the system to: determine that a current time is after an end of the period of time associated with the first object; and remove the first object from the database.

O: The system of any one of paragraphs J-N, wherein the first object is a first type of object and the period of time is a first period of time, and the instructions further cause the system to: receive, from the first client, a third request to retain, in association with at least the first virtual space, the first type of object for a second period of time and a second type of object for a third period of time that is shorter than the second period of time; receive a second object of the second type of object transmitted via the first virtual space, wherein the first object is transmitted in association with the second object; determine that a current time is after an end of the third period of time associated with the second object and before an end of the second period of time associated with the first object; remove the second object from the first virtual space based on a determination that the current time is after the end of the third period of time; and prior to receiving the second request to delete the first object, update an interface associated with the first virtual space to render the first object accessible via the first virtual space independently of the second object.

P: The system of any one of paragraphs J-O, wherein the first object is accessible in the database to an administrative user account associated with the organization.

Q: The system of any one of paragraphs J-P, wherein the instructions further cause the system to: receive, from the second client after removing the first object from the first virtual space, a third request to access data associated with the first object; determine that the indicator is associated with the first object; and cause a presentation, on an interface of the second client, of a message indicating that the first object is no longer accessible.

R: The system of any one of paragraphs J-Q, wherein the period of time is a first period of time, and the instructions further cause the system to: receive, from the second client and after a submission of the second request to delete the first object, a third request to access the first object; identify a second period of time associated with the second user accessing an object after a deletion of the object, the second period of time being shorter than the first period of time; determine that a current time is prior to an end of the second period of time; and cause a presentation, on an interface of the second client, of the first object based at least in part on a determination that the current time is prior to the end of the second period of time.

S: One or more non-transitory computer readable media storing instructions that, when executed, cause one or more processors to: receive, from a first client of a first user of an organization, a first request to retain deleted objects for a period of time, wherein a deleted object of the deleted objects comprises an object that is transmitted in association with a virtual space of the communication platform that is associated with the organization and is subsequently requested to be deleted by a second user of the organization; store, based at least in part on the first request, a first instruction to associate an indicator with the deleted objects; receive, from a second client associated with the second user of the organization, a second request to delete a first object associated with a first virtual space; associate the indicator with the first object based at least in part on at least one of the first request and the second request; remove the first object from the first virtual space based at least in part on the second request; and retain, based at least in part on the first object being associated with the indicator, the first object in a database associated with the communication platform for the period of time.

T: The one or more non-transitory computer readable media of paragraph S, wherein the instructions further cause the one or more processors to: receive, from at least one of the first client or a third-party computing device, a third request to receive stored data associated with the deleted objects; and send, to the at least one of the first client or the third-party computing device and based at least in part on the third request, data associated with the first object.

### CONCLUSION

While one or more examples of the techniques described herein have been described, various alterations, additions, permutations and equivalents thereof are included within the scope of the techniques described herein.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein can be presented in a certain order, in some cases the ordering can be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

What is claimed is:

1. A method implemented at least in part by a server computing device associated with a communication platform, the method comprising:
receiving, from a first client of a first user of an organization, a first request to retain deleted objects for a period of time, wherein a deleted object of the deleted objects comprises an object that is transmitted in association with a virtual space of the communication platform that is associated with the organization and is subsequently requested to be deleted by a second user of the organization;
storing, based at least in part on the first request, a first instruction to associate an indicator with the deleted objects;
receiving, from a second client associated with the second user of the organization, a second request to delete a first object associated with a first virtual space;
associating the indicator with the first object based at least in part on at least one of the first request and the second request;
removing the first object from the first virtual space based at least in part on the second request; and
retaining, based at least in part on the first object being associated with the indicator, the first object in a database associated with the communication platform for the period of time.

2. The method of claim 1, further comprising:
receiving, from at least one of the first client or a third-party computing device, a third request to receive stored data associated with the deleted objects; and
sending, to the at least one of the first client or the third-party computing device and based at least in part on the third request, data associated with the first object.

3. The method of claim 1, wherein the object comprises at least one of:
a file;
a calendar event;
a workflow;
a reaction emoji;
an audio conversation;
a video conversation; or
a transcript of a conversation.

4. The method of claim 1, wherein the first request to retain deleted objects comprises a request to retain a first type of object, the method further comprising:
receiving, from a third client associated with a third user of the organization, a third request to delete a second object associated with a second virtual space;
determining that the second object comprises a second type of object; and
removing the second object from the database based at least in part on a determination that the second object comprises the second type of object different than the first type of object.

5. The method of claim 1, further comprising:
determining that a current time is after an end of the period of time associated with the first object; and
removing the first object from the database.

6. The method of claim 1, wherein the first object is a first type of object and the period of time is a first period of time, the method further comprising:
receiving, from the first client, a third request to retain, in association with at least the first virtual space, the first type of object for a second period of time and a second type of object for a third period of time that is shorter than the second period of time;
receiving a second object of the second type of object transmitted via the first virtual space, wherein the first object is transmitted in association with the second object;
determining that a current time is after an end of the third period of time associated with the second object and before an end of the second period of time associated with the first object;
removing the second object from the first virtual space based on a determination that the current time is after the end of the third period of time; and
prior to receiving the second request to delete the first object, updating an interface associated with the first virtual space to render the first object accessible via the first virtual space independently of the second object.

7. The method of claim 1, wherein the first object is accessible in the database to an administrative user account associated with the organization.

8. The method of claim 1, further comprising:
receiving, from the second client after removing the first object from the first virtual space, a third request to access data associated with the first object;
determining that the indicator is associated with the first object; and
causing a presentation, on an interface of the second client, of a message indicating that the first object is no longer accessible.

9. The method of claim 1, wherein the period of time is a first period of time, the method further comprising:
receiving, from the second client and after a submission of the second request to delete the first object, a third request to access the first object;
identifying a second period of time associated with the second user accessing an object after a deletion of the object, the second period of time being shorter than the first period of time;
determining that a current time is prior to an end of the second period of time; and
causing a presentation, on an interface of the second client, of the first object based at least in part on a determination that the current time is prior to the end of the second period of time.

10. A system comprising:
one or more processors; and
one or more non-transitory computer readable media storing instructions that, when executed, cause the system to:
receive, from a first client of a first user of an organization associated with a communication platform, a first request to retain deleted objects for a period of time, wherein a deleted object of the deleted objects comprises an object that is transmitted in association with a virtual space of the communication platform that is associated with the organization and is subsequently requested to be deleted by a second user of the organization;
store, based at least in part on the first request, a first instruction to associate an indicator with the deleted objects;
receive, from a second client associated with the second user of the organization, a second request to delete a first object associated with a first virtual space;
associate the indicator with the first object based at least in part on at least one of the first request and the second request;
remove the first object from the first virtual space based at least in part on the second request; and
retain, based at least in part on the first object being associated with the indicator, the first object in a database associated with the communication platform for the period of time.

11. The system of claim 10, wherein the instructions further cause the system to:
receive, from at least one of the first client or a third-party computing device, a third request to receive stored data associated with the deleted objects; and
send, to the at least one of the first client or the third-party computing device and based at least in part on the third request, data associated with the first object.

12. The system of claim 10, wherein the object comprises at least one of:
a file;
a calendar event;
a workflow;
a reaction emoji;
an audio conversation;
a video conversation; or
a transcript of a conversation.

13. The system of claim 10, wherein the first request to retain deleted objects comprises a request to retain a first type of object, and the instructions further cause the system to:
receive, from a third client associated with a third user of the organization, a third request to delete a second object associated with a second virtual space;
determine that the second object comprises a second type of object; and
remove the second object from the database based at least in part on a determination that the second object comprises the second type of object different than the first type of object.

14. The system of claim 10, wherein the instructions further cause the system to:
determine that a current time is after an end of the period of time associated with the first object; and
remove the first object from the database.

15. The system of claim 10, wherein the first object is a first type of object and the period of time is a first period of time, and the instructions further cause the system to:
receive, from the first client, a third request to retain, in association with at least the first virtual space, the first type of object for a second period of time and a second type of object for a third period of time that is shorter than the second period of time;
receive a second object of the second type of object transmitted via the first virtual space, wherein the first object is transmitted in association with the second object;
determine that a current time is after an end of the third period of time associated with the second object and before an end of the second period of time associated with the first object;
remove the second object from the first virtual space based on a determination that the current time is after the end of the third period of time; and
prior to receiving the second request to delete the first object, update an interface associated with the first virtual space to render the first object accessible via the first virtual space independently of the second object.

16. The system of claim 10, wherein the first object is accessible in the database to an administrative user account associated with the organization.

17. The system of claim 10, wherein the instructions further cause the system to:
receive, from the second client after removing the first object from the first virtual space, a third request to access data associated with the first object;
determine that the indicator is associated with the first object; and
cause a presentation, on an interface of the second client, of a message indicating that the first object is no longer accessible.

18. The system of claim 10, wherein the period of time is a first period of time, and the instructions further cause the system to:
receive, from the second client and after a submission of the second request to delete the first object, a third request to access the first object;
identify a second period of time associated with the second user accessing an object after a deletion of the object, the second period of time being shorter than the first period of time;
determine that a current time is prior to an end of the second period of time; and
cause a presentation, on an interface of the second client, of the first object based at least in part on a determination that the current time is prior to the end of the second period of time.

19. One or more non-transitory computer readable media storing instructions that, when executed, cause one or more processors to:
receive, from a first client of a first user of an organization associated with a communication platform, a first request to retain deleted objects for a period of time, wherein a deleted object of the deleted objects comprises an object that is transmitted in association with a virtual space of the communication platform that is associated with the organization and is subsequently requested to be deleted by a second user of the organization;
store, based at least in part on the first request, a first instruction to associate an indicator with the deleted objects;
receive, from a second client associated with the second user of the organization, a second request to delete a first object associated with a first virtual space;
associate the indicator with the first object based at least in part on at least one of the first request and the second request;
remove the first object from the first virtual space based at least in part on the second request; and
retain, based at least in part on the first object being associated with the indicator, the first object in a database associated with the communication platform for the period of time.

20. The one or more non-transitory computer readable media of claim 19, wherein the instructions further cause the one or more processors to:
receive, from at least one of the first client or a third-party computing device, a third request to receive stored data associated with the deleted objects; and
send, to the at least one of the first client or the third-party computing device and based at least in part on the third request, data associated with the first object.
